(19) United States
(12) Patent Application Publication
(10) Pub. No.: US 2025/0319599 A1
(43) Pub. Date: Oct. 16, 2025

(54) ROBOTIC ARM CONTROL METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Shuai WANG, Shenzhen (CN); Yu ZHENG, Shenzhen (CN)

(21) Appl. No.: 19/191,952

(22) Filed: Apr. 28, 2025

Related U.S. Application Data
(63) Continuation of application No. PCT/CN2023/130371, filed on Nov. 8, 2023.

(30) Foreign Application Priority Data
Mar. 31, 2023 (CN) 202310360170.X

(51) Int. Cl. B25J 9/16; B25J 18/04

(52) U.S. Cl. CPC B25J 9/1679; B25J 9/1635; B25J 9/1669; B25J 18/04

(57) ABSTRACT

Disclosed are a robotic arm control method and apparatus, a device, and a storage medium, which belong to the field of robots. The method is performed by a controller of a robotic arm, and a three-dimensional object is placed at any position other than an end on the robotic arm. The method comprises controlling the robotic arm to throw the three-dimensional object; acquiring a first control signal; controlling, based on the first control signal, the robotic arm to catch the thrown three-dimensional object, the robotic arm catching the three-dimensional object at any position other than the end; acquiring a second control signal; and controlling the robotic arm based on the second control signal, to maintain the three-dimensional object in a force balance state at any position other than the end.

### RELATED APPLICATIONS

This application is a continuation of PCT Application PCT/CN2023/130371, filed on Nov. 8, 2023, which claims priority to Chinese Patent Application No. 202310360170.X, filed on Mar. 31, 2023, and entitled “ROBOTIC ARM CONTROL METHOD AND APPARATUS, DEVICE, AND STORAGE MEDIUM”, which are incorporated herein by reference in their entirety.

### FIELD OF THE TECHNOLOGY

This application relates to the field of robots, and in particular, to a robotic arm control method and apparatus, a device, and a storage medium.

### BACKGROUND OF THE DISCLOSURE

With the development of robotics and expansion of applicable fields, robots have gradually become irreplaceable tools in manufacturing, services, and the like. A robotic arm is a common actuator of the robot, and plays an important role in manufacturing and daily life.

Often, an end of the robotic arm is usually used to complete an operation task. Alternatively, an end effector is mounted at the end of the robotic arm to complete a corresponding operation. For example, a robotic finger is mounted at the end of the robotic arm, and an operation is completed by controlling motions of the robotic arm and the robotic finger.

### SUMMARY

This application provides a robotic arm control method and apparatus, a device, and a storage medium. The technical solutions are as follows.

One aspect of this application provides a robotic arm control method. The method is performed by a controller of a robotic arm, and a three-dimensional object is placed at any position other than an end on the robotic arm. The method comprises controlling the robotic arm to throw the three-dimensional object; acquiring a first control signal; controlling, based on the first control signal, the robotic arm to catch the thrown three-dimensional object, the robotic arm catching the three-dimensional object at any position other than the end; acquiring a second control signal; and controlling the robotic arm based on the second control signal, to maintain the three-dimensional object in a force balance state at any position other than the end.

Another aspect of this application provides a robotic arm comprising a memory and a controller, the memory having at least one piece of program code stored therein, and the controller loading and executing the program code to implement a robotic arm control method, the method being performed by a controller of the robotic arm and a three-dimensional object being placed at any position other than an end on the robotic arm, and the method comprising controlling the robotic arm to throw the three-dimensional object; acquiring a first control signal; controlling, based on the first control signal, the robotic arm to catch the thrown three-dimensional object, the robotic arm catching the three-dimensional object at any position other than the end; acquiring a second control signal; and controlling the robotic arm based on the second control signal, to maintain the three-dimensional object in a force balance state at any position other than the end.

Another aspect of this application provides a non-transitory computer-readable storage medium. The storage medium has a computer program stored therein, and a processor executes the computer program to implement the foregoing robotic arm control method.

The technical solutions provided in this application have at least the following beneficial effects: a method for using a robotic arm is provided. The robotic arm can first throw the three-dimensional object, catch the three-dimensional object at any position other than the end, and re-balance the three-dimensional object. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

### BRIEF DESCRIPTION OF THE DRAWINGS

FIG. 1 is a schematic diagram of a robotic arm according to an embodiment of this application.

FIG. 2 is a schematic diagram of a robotic arm according to an embodiment of this application.

FIG. 3 is a schematic diagram of a robotic arm according to an embodiment of this application.

FIG. 4 is a flowchart of a robotic arm control method according to an embodiment of this application.

FIG. 5 is a schematic diagram of a robotic arm according to an embodiment of this application.

FIG. 6 is a schematic diagram of a robotic arm according to an embodiment of this application.

FIG. 7 is a flowchart of a robotic arm control method according to an embodiment of this application.

FIG. 8 is a schematic diagram of a robotic arm and a three-dimensional object according to an embodiment of this application.

FIG. 9 is a flowchart of a robotic arm control method according to an embodiment of this application.

FIG. 10 is a flowchart of a robotic arm control method according to an embodiment of this application.

FIG. 11 is a schematic diagram of a robotic arm and a three-dimensional object according to an embodiment of this application.

FIG. 12 is a flowchart of a robotic arm control method according to an embodiment of this application.

FIG. 13 is a flowchart of a robotic arm control method according to an embodiment of this application.

FIG. 14 is a flowchart of a robotic arm control method according to an embodiment of this application.

FIG. 15 is a structural block diagram of a robotic arm control apparatus according to an embodiment of this application.

FIG. 16 is a schematic structural block diagram of a robotic arm according to an embodiment of this application.

### DESCRIPTION OF EMBODIMENTS

A robotic arm is a common actuator of a robot. With wide application of artificial intelligence (AI), the robotic arm plays an important role in production and life, and becomes an essential device.

During use of the robotic arm, an end of the robotic arm is usually used to complete an operation task. Alternatively, an end effector is mounted at the end of the robotic arm to complete a corresponding operation. For example, a robotic finger is mounted at the end of the robotic arm, and an operation is completed by controlling motions of the robotic arm and the robotic finger.

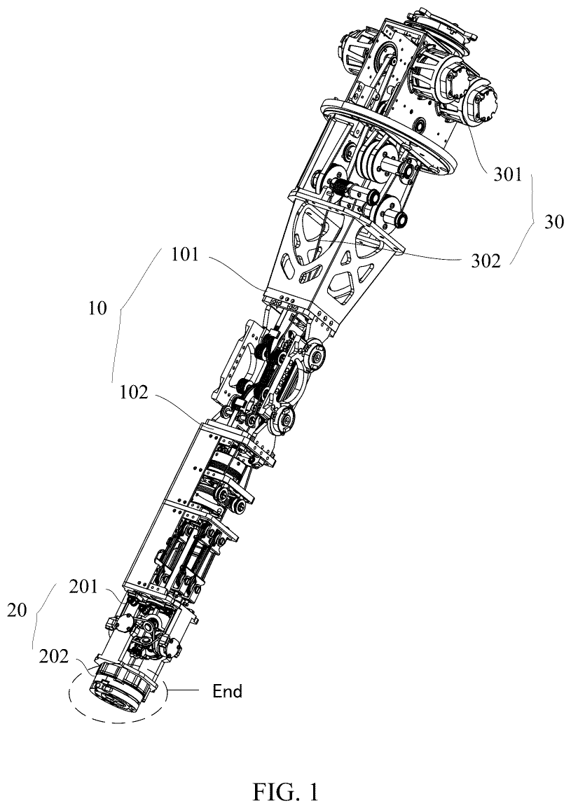

In the related art, a rigid body connecting member and/or a housing of the robotic arm is not considered for completing an operation task, and the main reason is as follows: first, the exterior of the robotic arm is usually curved and does not have a large plane; and second, without a design of a graspable mechanism such as a robotic finger, contact between the exterior of the robotic arm and an external object does not establish a form closure and force closure. Consequently, the robotic arm is difficult to control. FIG. 1 is a schematic diagram of a robotic arm according to an embodiment of this application.

In some embodiments, the robotic arm is a robotic arm with 7 degrees of freedom. Elbow and wrist control motors of the robotic arm are arranged in the hollow of a third joint of a back shoulder. In an embodiment, an elbow and a wrist are driven by cables which are powered by a motor located in a shoulder. The motor drives a cable pulley via a belt, and the cable pulley, driven by the belt, moves cables to control motions of the elbow and the wrist.

In one embodiment, the robotic arm includes: a first robotic 50, a second robotic joint 20, and a drive assembly 30. The first robotic joint 10 includes a first fixed member 101 and a first movable member 102 that are in rotational connection. The second robotic joint 20 includes a second fixed member 201 and a second movable member 202 that are in rotational connection. The second fixed member 201 is connected to the first movable member 102.

The drive assembly 30 includes at least two drive sources 301 and at least two drive cables 302. Each of the at least two drive sources 301 is connected to the first fixed member 101, the first movable member 102, and the second movable member 202 through at least one drive cable 302. The at least two drive sources 301 is switched between a first operation mode and a second operation mode.

In the first operation mode, the at least two drive sources 301 can drive the second movable member 202 to rotate relative to the second fixed member 201, and maintain the first movable member 102 in a fixed position relative to the first fixed member 101. In the second operation mode, the at least two drive sources 301 can drive the second movable member 202, the second fixed member 201, and the first movable member 102 to rotate relative to the first fixed member 101, and maintain the second movable member 202 in a fixed position relative to the second fixed member 201.

In this application, the robotic arm includes the first robotic joint 10, the second robotic joint 20, and the drive assembly 30. The drive assembly 30 includes at least two drive sources 301 and at least two drive cables 302. Each of the at least two drive sources 301 is connected to the first movable member 102 of the first robotic joint 10, the second movable member 202 of the second robotic joint 20, and the first fixed member 101 of the first robotic joint 10 through at least one drive cable 302. In the first operation mode, the at least two drive sources 301 can drive the second movable member 202 to rotate relative to the second fixed member 201, and maintain the first movable member 102 in a fixed position relative to the first fixed member 101. In the second operation mode, the at least two drive sources 301 can drive the second movable member 202, the second fixed member 201, and the first movable member 102 to rotate relative to the first fixed member 101, and maintain the second movable member 202 in a fixed position relative to the second fixed member 201. By implementing coupled driving of the at least two drive sources 301 for a plurality of joints, utilization of the drive sources 301 is improved, structural complexity of the robotic joint is reduced, a moment of inertia of the robotic joint is increased, and motion performance of the robotic joint is enhanced.

In addition, in this embodiment, independent motion of the second robotic joint 20 (that is, the second movable member 202 rotates relative to the second fixed member 201, but the position of the first movable member 102 remains fixed relative to the first fixed member 101) and coupled motion of the second robotic joint 20 driven by the first robotic joint 10 (that is, the second movable member 202, the second fixed member 201, and the first movable member 102 rotate relative to the first fixed member 101, and the position of the second movable member 202 remains fixed relative to the second fixed member 201) are both driven by the at least two drive sources 301. That is, joint motion corresponding to each degree of freedom is driven by power of the at least two drive sources 301. Compared with a solution in which a single degree of freedom is driven by a single drive source 301, coupled driving of the at least two drive sources 301 for a single movable member can be implemented. Accordingly, at least twice the traction force is achieved, which is beneficial to improving operation performance such as a rotation torque and a rotation velocity of the movable member.

In some embodiments, the at least two drive sources 301 include a motor and an active cable pulley that are connected through a transmission mechanism. The motor drives, through the transmission mechanism, the active cable pulley to rotate. The drive cable 302 is wrapped around the active cable pulley. When the active cable pulley rotates, the drive cable 302 can be tightly wrapped around the active cable pulley, whereby a traction force is applied to at least one of the first fixed member 101, the first movable member 102, and the second movable member 202 via the drive cable 302. In some embodiments, the transmission mechanism includes, but is not limited to, a belt transmission mechanism, a gear transmission mechanism, a worm transmission mechanism, and the like.

In one embodiment, the transmission mechanism is a belt transmission, which includes an active belt pulley, a transmission belt, and a passive belt pulley. The active belt pulley is connected to an output axis of the motor, the passive belt pulley is connected to the active cable pulley, and the transmission belt is connected between the active belt pulley and the passive belt pulley.

In one embodiment, the transmission mechanism is a belt transmission, which further includes a tensioning mechanism. The tensioning mechanism is close to the transmission belt and is configured to adjust the tension of the transmission belt.

In some embodiments, the first operation mode and the second operation mode are different operation modes formed according to different or same rotation directions of the at least two drive sources 301; different operation modes formed according to different or same rotation velocities of the at least two drive sources 301; or different operation modes formed according to different or same rotation directions and rotation velocities of the at least two drive sources 301. In some embodiments, in the first operation mode, the at least two drive sources 301 rotate in a same direction, and in the second operation mode, the at least two drive sources 301 rotate in opposite directions.

Therefore, according to the robotic arm of this embodiment, by controlling the rotation directions of the at least two drive sources 301, independent motion of the second robotic joint 20, and coupled motion of the second robotic joint 20 driven by the first robotic joint 10 can be controlled. The structure is simple, and coupling control efficiency is high. In some embodiments, in the first operation mode, the at least two drive sources 301 rotate in opposite directions, and in the second operation mode, the at least two drive sources 301 rotate in a same direction. In addition, in one embodiment, in both the first operation mode and the second operation mode, the rotation velocities and output torques of the at least two drive sources 301 are identical.

Referring to FIG. 1, in some embodiments, the at least two drive sources 301 are located on a side, facing away from the first movable member 102, of the first fixed member 101, and the at least two drive cable 302 pass through the first fixed member 101 and are connected to the first movable member 102, and pass through the second fixed member 201 and are connected to the second movable member 202. Therefore, according to the robotic arm of this embodiment, the at least two drive sources 301 are arranged on the side, facing away from the first movable member 102, of the first fixed member 101, and the drive cables 302 pass through the first fixed member 101 and are connected to the first movable member 102, and pass through the second fixed member 201 and are connected to the second movable member 202. The mass of the at least two drive sources 301 is concentrated on the side of the first fixed member 101, and the mass of the at least two drive sources 301 on the side of the first movable member 102, the second fixed member 201, and the second movable member 202 is relatively small, which helps to improve a moment of inertia of the side of the first movable member 102, the second fixed member 201, and the second movable member 202, and improve operation performance of the first movable member 102, the second fixed member 201, and the second movable member 202.

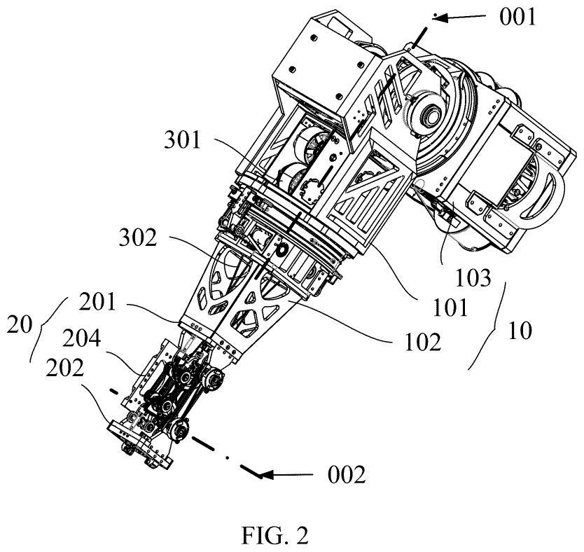

Referring to FIG. 2, in some embodiments, the first robotic joint 10 is a robotic shoulder joint, and the second robotic joint 20 is a robotic elbow joint. The first fixed member 101 and the first movable member 102 are in rotational connection along a first axis 001. The second fixed member 201 and the second movable member 202 are in rotational connection along a second axis 002.

In the first operation mode, the at least two drive sources 301 can drive the second movable member 202 to rotate about the second axis 002 relative to the second fixed member 201, and maintain the first movable member 102 in a fixed position relative to the first fixed member 101. In the second operation mode, the at least two drive sources 301 can drive the second robotic joint 20 and the first movable member 102 to rotate about the first axis 001 relative to the first fixed member 101, and maintain the second movable member 202 in a fixed position relative to the second fixed member 201.

In some other embodiments, the first robotic joint 10 is a robotic shoulder joint, and the second robotic joint 20 is a robotic elbow joint. In the first operation mode, the at least two drive sources 301 can drive the second movable member 202 of the robotic elbow joint to rotate about the second axis 002 relative to the second fixed member 201 of the robotic elbow joint, and maintain the first movable member 102 of the robotic shoulder joint in a fixed position relative to the first fixed member 101 of the robotic shoulder joint, to implement independent motion of the robotic elbow joint.

In the second operation mode, the at least two drive sources 301 can drive the first movable member 102 of the robotic shoulder joint, which, in turn, drives the entire robotic elbow joint (including the second fixed member 201 and the second movable member 202) to rotate about the first axis 001 relative to the first fixed member 101 of the robotic shoulder joint, and maintain the second movable member 202 of the robotic elbow joint in a fixed position relative to the second fixed member 201 of the robotic elbow joint, to implement coupled motion of the robotic elbow joint and the robotic shoulder joint.

In one embodiment, the robotic arm applies a set of drive sources 301, and the controller can respectively drive the robotic elbow joint and the robotic shoulder joint by controlling the set of drive sources 301 to operate in different operation modes. Degrees of freedom of both the robotic elbow joint and the robotic shoulder joint can be traction driven by the at least two drive sources 301. Accordingly, at least twice the traction force is achieved, which is beneficial to improving operation performance such as rotation torques and rotation velocities of the robotic elbow joint and the robotic shoulder joint.

In some embodiments, the robotic arm further includes a robotic wrist joint. The robotic shoulder joint is connected to the robotic elbow joint, and the robotic wrist joint is connected to the robotic elbow joint, to form a complete robotic arm. In some embodiments, the at least two drive sources 301 are located in the second movable member 202, are connected to the second movable member 202, and move with the second movable member 202.

Referring to FIG. 2, in some embodiments, the first axis 001 is perpendicular to and intersects with the second axis 002. Therefore, the first robotic joint 10 (such as a robotic shoulder joint) can drive the second robotic joint 20 (such as a robotic elbow joint) to rotate, to simulate forearm rotation motion of an arm of a human body. The second robotic joint 20 can rotate in a wide range (such as 0° to 360°) in space, which enriches action scenes of the robotic arm, and improves an application range of the robotic arm. Referring to FIG. 2, in some embodiments, the first robotic joint 10 further includes a third fixed member 103. The first fixed member 101 and the third fixed member 103 are in rotational connection. Therefore, the first robotic joint 10 includes the third fixed member 103, the first fixed member 101, and the first movable member 102 that are in rotational connection in sequence. In some embodiments, the first fixed member 101 is driven, by a shoulder drive assembly, to rotate relative to the second fixed member 201, to simulate lifting motion of a shoulder joint of an arm of a human body. The second fixed member 201 is fixedly connected to a torso or another support structure of a robot, and is configured to fixedly support the entire robotic arm.

Referring to FIG. 2, in some embodiments, the second robotic joint 20 further includes a first connecting member 203. The second fixed member 201 and the first connecting member 203 are in rotational connection, and the first connecting member 203 and the second movable member 202 are in rotational connection. Therefore, according to the robotic arm of this embodiment, the second fixed member 201 and the second movable member 202 in the second robotic joint 20 are in rotational connection through the first connecting member 203. Accordingly, the second axis 002 can be arranged away from the second fixed member 201, and an angle by which the second movable member 202 can rotate relative to the second fixed member 201 is significantly expanded.

According to the robotic arm of this embodiment, the at least two drive sources 301 include two elbow active cable pulleys that are mounted inside the first movable member 102 and are configured to respectively drive two elbow drive cables 302. The two elbow drive cables 302 are wrapped around the two elbow active cable pulleys, which implements connection between the drive cables 302 and the first movable member 102.

The at least two drive cables 302 include the two elbow drive cables 302. The two elbow drive cables 302 are respectively connected to the first fixed member 101, the first movable member 102, and the second movable member 202, are respectively connected to a first position and a second position of the second movable member 202, and are finally connected to the second movable member 202 in opposite wrapping directions.

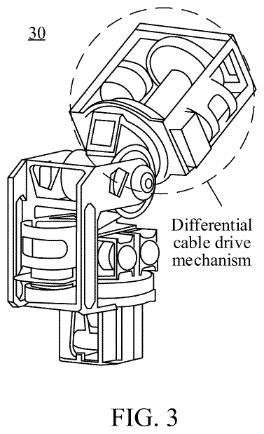

Referring to FIG. 3, a description is made by using one embodiment in which the first robotic joint 10 is a robotic shoulder joint. In a low-inertia differential shoulder joint structure of a robotic arm with 7 degrees of freedom, a differential cable drive mechanism is applied to a shoulder, which can reduce a weight of the mechanism and implement back arrangement of a motor module, and may further implement torque superposition in some cases. A third degree of freedom of a shoulder joint is implemented by a pair of large and small pulley, and transmission is performed in a cable drive manner, whereby transmission precision is further improved and the weight is further reduced. Finally, drive modules of a wrist joint and an elbow joint are arranged behind a shoulder joint upper arm module, whereby a weight of the entire robotic arm is reduced.

Refer to the foregoing content. The end of the robotic arm is usually used to complete an operation task. The embodiments of this application provide a robotic arm control method. According to the method, a robotic arm can complete a task of throwing and catching a three-dimensional object with a non-end link, and balance the three-dimensional object at any position on the robotic arm other than an end.

A description is made by using one embodiment in which the three-dimensional object is a bottle. For a robotic arm with a plurality of degrees of freedom, according to the robotic arm control method provided in the embodiments of this application, the robotic arm throws up a three-dimensional object (such as a bottle) and then catches the thrown three-dimensional in the air with a non-end link (such as a forearm of the robotic arm). The control method provided in the embodiments of this application may be implemented by the foregoing controller of the robotic arm. The controller may be arranged in the robotic arm, or may be arranged outside the robotic arm and is in wired or wireless connection with the robotic arm, to control motions of the robotic arm.

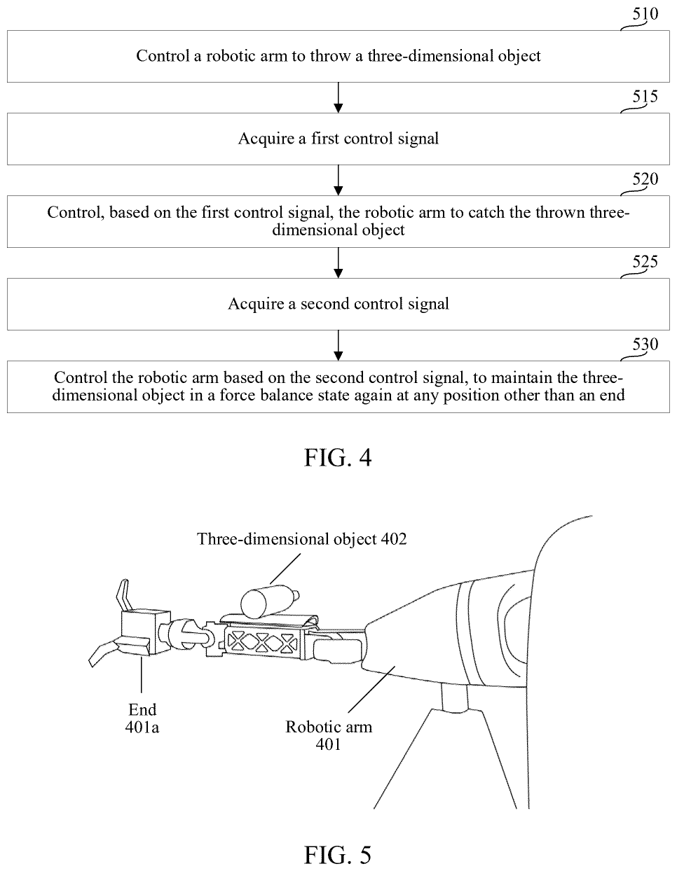

FIG. 4 is a flowchart of a robotic arm control method according to an embodiment of this application. The method may be performed by a controller of a robotic arm. The method includes the following operations.

Operation 510: Control the robotic arm to throw a three-dimensional object.

In one embodiment, the three-dimensional object is placed at any position on the robotic arm other than an end, and the action of throwing up the three-dimensional object of the robotic arm indicates that the three-dimensional object is separated from the robotic arm. Further, for example, there is no interaction force between the three-dimensional object and the robotic arm, and there is no contact point between the three-dimensional object and the robotic arm. In one embodiment, a shape, a size, a material, a mass, and the like of the three-dimensional object are not limited. Further, at least one outer surface of the three-dimensional object is a curved surface, or at least one edge of the outer surface of the three-dimensional object is a curve. In one embodiment, the three-dimensional object can roll and/or slide on the robotic arm under the gravity. For example, the three-dimensional object is a bottle, a bar, a sphere, an irregular object, or the like. Still further, a cross section of the three-dimensional object is a circle, an ellipse, or a closed shape formed by a curve.

FIG. 5 is a schematic diagram of a robotic arm according to an embodiment of this application. A three-dimensional object 402 is placed at any position on a robotic arm 401 other than an end 401a. Refer to FIG. 5. A description is made by using one embodiment in which the three-dimensional object 402 is a bottle. The bottle is placed on a forearm of the robotic arm 401. In one embodiment, the robotic arm throws up the three-dimensional object, and the three-dimensional object obtains a vertical upward velocity. A vertical upward direction is opposite to a gravity direction. Further, a component of a velocity of the three-dimensional object in the vertical upward direction is a positive value. Whether the three-dimensional object has a velocity component in another direction is not limited in this embodiment. For example, the three-dimensional object further has a velocity component in any direction on a plane perpendicular to a vertical direction.

Operation 515: Acquire a first control signal.

In one embodiment, the first control signal is configured to control the robotic arm to catch the thrown three-dimensional object at any position other than the end. In an embodiment, the first control signal controls the robotic arm to move with reference to motion trajectory information of the three-dimensional object. The first control signal may be generated by the controller, or may be generated by another device and transmitted to the controller. A method for acquiring the first control signal is not limited in this application. In one embodiment, the first control signal carries control information, and a method for transmitting the first control signal includes, but is not limited to, at least one of an electrical signal and an optical signal. In one embodiment, the first control signal is also referred to as first control information. Similarly, a second control signal below may also be referred to as second control information. A third control signal, a fourth control signal, and other more control signals herein are similar to the above and are not exemplified one by one. The first control signal may be configured to control the robotic arm to move along one or more rotation axes. The first control signal usually controls, by controlling a torque, the robotic arm to move.

Operation 520: Control, based on the first control signal, the robotic arm to catch the thrown three-dimensional object.

In one embodiment, the robotic arm catches the three-dimensional object at any position other than the end, that is, the robotic arm performs nonprehensile manipulation on the three-dimensional object at any position other than the end. Contact between any position on the robotic arm other than the end and the three-dimensional object does not constitute at least one of form closure and force closure for the three-dimensional object.

In addition, in this operation, the robotic arm catches the thrown three-dimensional object during motion of the three-dimensional object in space, that is, the three-dimensional object is caught by a non-end link of the robotic arm when moving in space. In one embodiment, after the robotic arm throws up the three-dimensional object, the three-dimensional object is separated from the robotic arm, and moves in space according to parabolic motion or parabolic-like motion. In this operation, the robotic arm catches the moving three-dimensional object. Further, before the robotic arm grasps the three-dimensional object, at least one of a position, a velocity, and an acceleration of the three-dimensional object changes, and the three-dimensional object is moving. Further, when the robotic arm catches the three-dimensional object, the robotic arm is in contact with the three-dimensional object.

Operation 525: Acquire a second control signal.

In one embodiment, the second control signal is configured to control the robotic arm to move, to re-balance the three-dimensional object at any position other than the end. Similar to the first control signal, a method for acquiring the second control signal is not limited in this application. Similar to the first control signal, the second control signal may be configured to control the robotic arm to move along one or more rotation axes. The second control signal usually controls, by controlling a torque, the robotic arm to move.

Operation 530: Control the robotic arm based on the second control signal, to maintain the three-dimensional object in a force balance state again at any position other than the end.

In one embodiment, the three-dimensional object reaches the force balance state again on the robotic arm, that is, the three-dimensional object is in balance on the robotic arm. In this operation, an objective of controlling the robotic arm is to ensure that the three-dimensional object is in a balance state on the robotic arm, and is always in balance on the robotic arm without falling. In one embodiment, the force balance state (also referred to as being in balance) of the three-dimensional object includes at least one of the following two states: a static balance state in which the three-dimensional object is stationary on the robotic arm; and a dynamic balance state in which the three-dimensional object moves or rolls on the robotic arm without falling. In this embodiment, a velocity and a direction of movement or rolling of a movable object on the robotic arm are not limited. In one embodiment, the balance state is configured to indicate that the movable object is in a state of force balance. In this case, the movable object may no longer move, or may be in a state of uniform linear motion relative to the robotic arm. Further, a moving velocity of the movable object is less than a preset velocity, such as 1 centimeter per second, that is, the movable object is in a state of small motion. Still further, the balance state is configured to indicate that the movable object is in a state of force balance and no longer moves (the movable object remains stationary relative to the robotic arm).

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

According to the robotic arm control method provided in this application, the method of controlling a robotic arm to throw a three-dimensional object and then catching the thrown three-dimensional object may be implemented by one robotic arm, or may be implemented by two robotic arms. Details are described below. In addition, the following two embodiments in which one or two robotic arms throw and catch the three-dimensional object and maintain the balance of the three-dimensional object may be combined with other embodiments of this application to form a new embodiment. This is not limited in this application.

In one embodiment, the robotic arm control method is performed by a controller of a robotic arm. In the embodiment shown in FIG. 4, operation 510 may be implemented as sub-operation 1, operation 520 may be implemented as sub-operation 2, and operation 530 may be implemented as sub-operation 3.

Sub-operation 1: Control a first arm to throw a three-dimensional object.

In one embodiment, the robotic arm includes the first arm. In addition, a structure of the first arm is not limited in this embodiment. In one embodiment, the first arm is the robotic arm with a plurality of degrees of freedom shown in FIG. 1. In this embodiment, the method for controlling a robotic arm to throw a three-dimensional object and then catch the thrown three-dimensional object is implemented by the first arm. In one embodiment, the action of throwing up the three-dimensional object of the first arm indicates that the three-dimensional object is separated from the first arm.

Sub-operation 2: Control, based on a first control signal, the first arm to catch the thrown three-dimensional object.

In one embodiment, the first arm performs nonprehensile manipulation on the three-dimensional object at any position other than an end. In one embodiment, nonprehensile manipulation is configured to indicate that a robotic hand or a claw-like structure is not needed to perform prehensile manipulation. In one embodiment, nonprehensile manipulation is configured to indicate that by adjusting an angle, a position, or the like of the first arm, the three-dimensional object gets in contact with a forearm or an upper arm of the first arm. Contact between any position on the first arm other than the end and the three-dimensional object does not constitute at least one of form closure and force closure for the three-dimensional object. In one embodiment, form closure refers to a contact and closure state achieved through matching of shapes of two objects. Form closure may be implemented through matching of geometrical shapes, for example, through matching of a concave shape and a convex shape, or through matching of assembly parts such as a thread and a gear. In one embodiment, force closure refers to a contact and closure state achieved by applying a force to two objects. When a contact surface between two objects is subjected to sufficient pressure or friction, contact and closure may be kept by applying a force. Force closure may be implemented by applying an external force, for example, two objects are fastened together through a bolt, or a workpiece is fixed on a work table by using a jig. In one embodiment, the end of the robotic arm is configured to indicate an end, away from a shoulder joint, of the robotic arm. In some embodiments, the robotic arm includes a plurality of links connected head to tail. For example, the robotic arm includes a link 1 and a link 2, a first end of the link 1 is a shoulder joint, a second end of the link 1 is connected to a first end of the link 2, and the end is configured to indicate a second end of the link 2. In some embodiments, the end is further understood as a robotic apparatus connected to the end, away from the shoulder joint, of the robotic arm, such as a robotic hand providing a grasping function, a magnetic sucker providing an adsorption capability, or a bionic hand providing a bionic motion capability. For example, the robotic arm includes a link 1 and a link 2, a first end of the link 2 is connected to the link 1, a second end of the link 2 is a robotic hand, and the end is configured to indicate the robotic hand on the link 2. In this embodiment, the end of the first arm is configured to indicate the end, away from the shoulder joint, of the independently movable first arm in the robotic arm. Similarly, an end of a second arm is configured to indicate an end, away from a shoulder joint, of the independently movable second arm in the robotic arm. The introduction about the end of the robotic arm in this embodiment may be applied to operation 520 in the foregoing content, or may be applied to sub-operation 5 and sub-operation 6 in the following content, and other embodiments. This is not limited in this application.

Sub-operation 3: Control the first arm based on a second control signal, to maintain the three-dimensional object in a force balance state again at any position other than the end.

In one embodiment, the three-dimensional object is re-balanced on the first arm. In this operation, an objective of controlling the first arm is to ensure that the three-dimensional object is in a balance state on the first arm, and is always in balance on the first arm without falling.

In conclusion, according to the method provided in this embodiment, a method for using a robotic arm is provided, which is completed by one arm. The first arm can be controlled to first throw the three-dimensional object, catch the three-dimensional object at any position on the first arm other than the end, and re-balance the three-dimensional object. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

In one embodiment, the robotic arm control method is performed by a controller of a robotic arm. In the embodiment shown in FIG. 4, operation 510 may be implemented as sub-operation 4, operation 520 may be implemented as sub-operation 5, and operation 530 may be implemented as sub-operation 6.

Sub-operation 4: Control a first arm to throw a three-dimensional object.

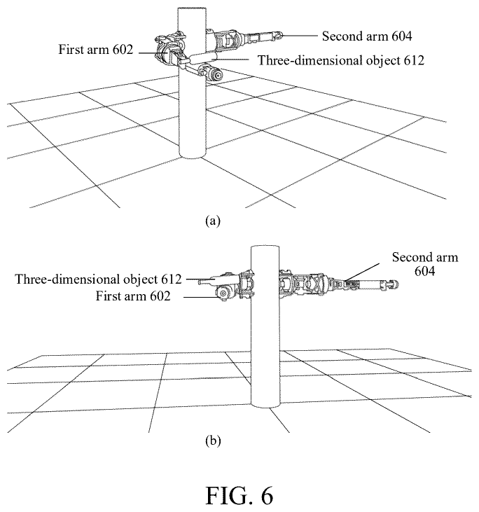

In one embodiment, the robotic arm includes a first arm and a second arm that move independently of each other. In addition, structures of the first arm and the second arm are not limited in this embodiment. In one embodiment, each of the first arm and the second arm is the robotic arm with a plurality of degrees of freedom shown in FIG. 1. FIG. 6 is a schematic diagram of a robotic arm according to an embodiment of this application. Sub-graph (a) is a side view of the robotic arm, and sub-graph (b) is a front view of the robotic arm. A first arm 602 throws up a three-dimensional object 612; and a second arm 604 catches the thrown three-dimensional object 612 at any position other than an end, and re-balances the three-dimensional object 612 at any position other than the end. In the figure, a description is made by using one embodiment in which the three-dimensional object 612 is a bottle. A shape feature of the three-dimensional object is not limited in this application.

Sub-operation 5: Control, based on a first control signal, a second arm to catch the thrown three-dimensional object.

In one embodiment, the second arm performs nonprehensile manipulation on the three-dimensional object at any position other than an end. Contact between any position on the second arm other than the end and the three-dimensional object does not constitute at least one of form closure and force closure for the three-dimensional object.

Sub-operation 6: Control the second arm based on a second control signal, to maintain the three-dimensional object in a force balance state again at any position other than the end.

In one embodiment, the three-dimensional object is re-balanced on the second arm. In this operation, an objective of controlling the second arm is to ensure that the three-dimensional object is in a balance state on the second arm, and is always in balance on the second arm without falling.

In conclusion, according to the method provided in this embodiment, a method for using a robotic arm is provided, which is implemented by two arms. The first arm can be controlled to first throw the three-dimensional object, and then the second arm is controlled to catch the three-dimensional object at any position on the second arm other than the end, and re-balance the three-dimensional object. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

Next, the action of catching the thrown three-dimensional object of the robotic arm is described.

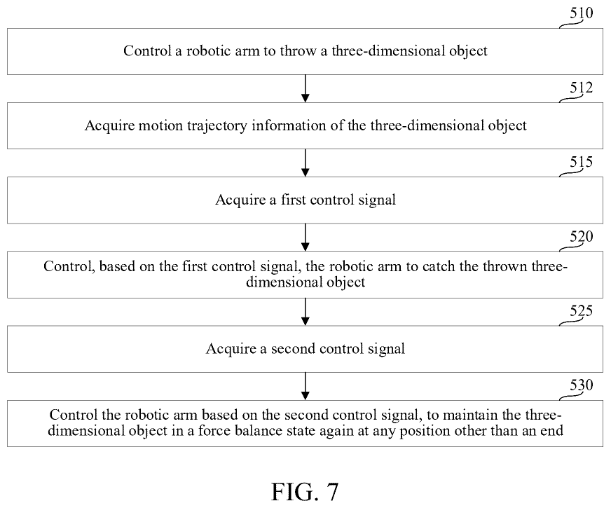

FIG. 7 is a flowchart of a robotic arm control method according to an embodiment of this application. The method may be performed by a controller of a robotic arm. That is, based on the embodiment shown in FIG. 4, the method further includes operation 512.

Operation 512: Acquire motion trajectory information of the three-dimensional object.

In one embodiment, the motion trajectory information of the three-dimensional object is a motion trajectory of the three-dimensional object after being thrown into air. In one embodiment, the motion trajectory information includes a motion trajectory of a center of mass of the three-dimensional object, or includes a motion trajectory of at least one point on an outer surface of the three-dimensional object or in the three-dimensional object. This is not limited in this embodiment.

In one embodiment, the motion trajectory information is usually predicted based on information about the three-dimensional object that is thrown up by the robotic arm, but the motion trajectory information may alternatively be obtained or predicted by measuring posture information of the three-dimensional object in the air.

In an alternative implementation, the information about the three-dimensional object that is thrown up by the robotic arm includes a position feature and a force-bearing feature of the three-dimensional object before the robotic arm throws up the three-dimensional object. The motion trajectory information is predicted based on the position feature and the force-bearing feature of the three-dimensional object before the robotic arm throws up the three-dimensional object. Further, the position feature of the three-dimensional object includes, but is not limited to, position information of the three-dimensional object before the three-dimensional object is separated from the robotic arm. The force-bearing feature of the three-dimensional object includes, but is not limited to, at least one of force-bearing information of the three-dimensional object before the three-dimensional object is separated from the robotic arm, a joint angular position of the robotic arm, a joint angular velocity of the robotic arm, current information of the robotic arm, and a torque of the robotic arm. In a specific example, the position feature and the force-bearing feature of the three-dimensional object are sequential values changing with time. The foregoing information may be represented in the form of a vector or a matrix. A time difference between adjacent values in the sequential value may be predetermined, or may be carried in a sequence. This is not limited in this embodiment.

In one embodiment, the first control signal is determined according to a first actual posture of the robotic arm and the motion trajectory information of the three-dimensional object. The first control signal is determined for the robotic arm according to the first actual posture of the robotic arm and the motion trajectory information of the three-dimensional object.

In one embodiment, the motion trajectory information is a parabolic trajectory of the three-dimensional object after the three-dimensional object is separated from the robotic arm. The first actual posture of the robotic arm is configured to indicate posture and position information of the robotic arm at a current timestamp. For example, the posture information is described by using at least one of an angle and an angular velocity of the robotic arm. The first control signal is configured to control any position on the robotic arm other than the end to catch the thrown three-dimensional object. In one embodiment, a motion mode of the robotic arm is obtained based on the motion trajectory information, which enables the robotic arm to catch the thrown three-dimensional object in a suitable posture. In one embodiment, the robotic arm is instructed to move with reference to the motion trajectory information of the three-dimensional object, and the motion mode of the robotic arm that is indicated by the first control signal gradually reduces a relative velocity between any position on the robotic arm other than the end and the three-dimensional object. Accordingly, any position on the robotic arm other than the end is stationary relative to the three-dimensional object, and the robotic arm catches the three-dimensional object.

In some embodiments, the robotic arm control method provided in the embodiments of this application is implemented by a proportion integration differentiation (PID) controller. The PID controller is a feedback loop component used in an industrial control application. According to a control principle of the PID controller, collected data may be compared with a corresponding reference value (which may be understood as an expected value or a target value), and a new input values is calculated based on a difference between the collected data and the corresponding reference value. An objective of the new input value is to enable data of a system to reach or remain at the reference value. In one embodiment, according to the first control signal, the robotic arm is controlled to catch the thrown three-dimensional object at any position other than the end.

After the first control signal is determined, the robotic arm may be controlled according to the first control signal.

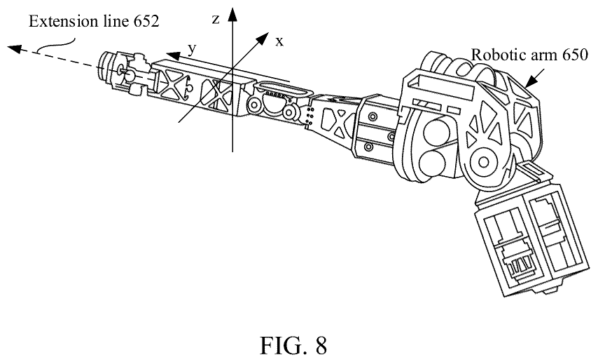

Further, the first control signal may be a control signal for one or more rotation axes, and the first control signal is usually configured to control motions of the robotic arm by controlling a torque. FIG. 8 is a schematic diagram of a robotic arm and a three-dimensional object according to an embodiment of this application. In one embodiment, FIG. 8 is a schematic diagram of a fully extended robotic arm. A direction of an extension line 652 of the extended robotic arm 650 is defined as a y direction, a direction of a horizontal line perpendicular to the extension line of the extended robotic arm 650 is defined as an x direction, and a direction of a longitudinal line perpendicular to the extension line of the extended robotic arm 650 is defined as a z direction. The first control signal may be configured to control the robotic arm to rotate about at least one rotation axis in the x direction, the y direction, or the z direction.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm, that is, determines the first control signal according to the first actual posture of the robotic arm and the motion trajectory information of the three-dimensional object, and controls the robotic arm to catch the thrown three-dimensional object at any position other than the end. Therefore, a method for controlling a robotic arm to throw and catch a three-dimensional object at any position other than an end and maintain the balance of the three-dimensional object is developed.

In one embodiment, the robotic arm control method is performed by a controller of a robotic arm. In the embodiment shown in FIG. 7, operation 515 may be implemented as sub-operation 11 and sub-operation 12.

Sub-operation 11: Determine a first expected posture of a robotic arm according to the motion trajectory information of the three-dimensional object.

In one embodiment, the first expected posture may be identical to the motion trajectory information, or may be determined based on the motion trajectory information. The first expected posture is determined according to the motion trajectory information of the three-dimensional object. In one embodiment, the first expected posture is determined by modifying the motion trajectory information of the three-dimensional object according to a shape feature of the three-dimensional object. Modification of the motion trajectory information based on the shape feature of the three-dimensional object is to ensure contact between the robotic arm and the three-dimensional object. Specifically, the motion trajectory information of the three-dimensional object is modified based on the shape feature of the three-dimensional object, to determine the first expected posture. Accordingly, any position on the robotic arm other than the end (for example, the forearm of the robotic arm shown in FIG. 5) gets in contact with a lower edge of the three-dimensional object in a vertical direction. In one embodiment, the vertical direction and a direction of the earth gravity are on a same straight line, and a horizontal plane is a plane in which a horizontal direction perpendicular to the direction of the earth gravity is located.

Sub-operation 12: Determine a first control signal according to a difference between a first actual posture and the first expected posture.

In one embodiment, the first expected posture is configured to indicate posture information of the robotic arm catching the thrown three-dimensional object. For the first actual posture and the first expected posture, refer to the foregoing descriptions. In one embodiment, the first actual posture includes an angle and an angular velocity of rotation of the robotic arm about a first rotation axis. Correspondingly, the first expected posture includes an expected angle and an expected angular velocity of rotation of the robotic arm about the first rotation axis, and the first control signal includes a first control torque. In one embodiment, the difference between the first actual posture and the first expected posture is configured to indicate a difference between a current actual posture and a posture of the robotic arm catching the thrown three-dimensional object. The difference is configured to indicate that the first control signal is determined by taking the current actual posture as a reference, and taking the first expected posture as a motion target. The first control signal is configured to control the robotic arm to move to the first expected posture by taking the current actual posture as a reference. In one embodiment, the first control signal is determined based on a product of a control parameter and the foregoing difference.

In one embodiment, this operation may be implemented as the following sub-operations.

The first control torque is determined according to a difference between the angle and the expected angle, and a difference between the angular velocity and the expected angular velocity.

The first control torque is configured to indicate a torque applied in a roll angle direction of rotation of the robotic arm about the first rotation axis, and the first rotation axis is a horizontal line perpendicular to the robotic arm; and/or the first control torque is configured to indicate a torque applied in a pitch angle direction of rotation of the robotic arm about the first rotation axis, and the first rotation axis is an extension line of the robotic arm. Refer to FIG. 8. The first rotation axis is the x direction and/or the y direction in FIG. 8. In an embodiment, the extension line of the robotic arm indicates an extension direction of the robotic arm when the robotic arm is straightened. In one embodiment, FIG. 8 shows the extension line of the straightened robotic arm. In one embodiment, the extension line is a ray pointing from the end of the robotic arm to outside the robotic arm. A direction of the extension line is parallel to a direction pointing from a center of mass of the forearm of the robotic arm to the end of the robotic arm. For example, in FIG. 8, the extension line is parallel to the y axis. In one embodiment, the extension line in FIG. 8 starts from the forearm of the robotic arm. In one embodiment, the extension line may start from any position on the robotic arm. In another implementation, the direction of the extension line is indicated by using a ray starting from a position other than the robotic arm. This is not limited in this embodiment. In one embodiment, there is a first difference between the angle and the expected angle, and there is a second difference between the angular velocity and the expected angular velocity. A sum of a first product and a second product is determined as the first control torque. The first product is a product of the first difference and a first control parameter, and the first control parameter is also referred to as a proportional control parameter. The second product is a product of the second difference and a second control parameter, and the second control parameter is also referred to as a differential control parameter. Further, a sum of the first product, the second product, and a third product is determined as the first control torque. The third product is a product of an integral calculation result of the first difference and a third control parameter, and the third control parameter is also referred to as an integral control parameter.

Specifically, the robotic arm control method provided in the embodiments of this application is performed by the PID controller, and a control signal is further determined according to at least one of the proportional control parameter, the differential control parameter, and the integral control parameter. According to the control principle of the PID controller, a description is made by using one embodiment in which the first control signal is the first control torque, the PID controller may be implemented by using the following formula:

$$τ = {k}_{p} ( {a}^{r e f} - a ) + {k}_{d} ( {\dot{a}}^{r e f} - \dot{a} ) + {k}_{i} {\int }_{{t}_{s}}^{{t}_{f}} ( {a}^{r e f} - a ) dt ;$$

where, τ represents the first control torque, a represents the angle of rotation about the first rotation axis in the first actual posture, \dot{a} represents the angular velocity of rotation about the first rotation axis in the first actual posture, \dot{a} is a first-order derivative of a about time, a^{ref} and \dot{a}^{ref} represent the first expected posture, and specifically, the expected angle and the expected angular velocity of rotation of the robotic arm about the first rotation axis that are included in the first expected posture, and kₚ, k_{d}, and kᵢ respectively represent the proportional control parameter, the differential control parameter, and the integral control parameter. In one embodiment, the proportional control parameter, the differential control parameter, and the integral control parameter are usually preset empirical values. tₛ and t_{f} respectively represent a start moment and a finish moment of the first control torque.

In addition, in one embodiment, the first control torque is configured to control the robotic arm in the x direction and the y direction in FIG. 8, respectively. For example, the first control torque includes two sub-torques, which are configured to respectively control the robotic arm in the foregoing two directions. The formula of the first control torque may be implemented as the following two formulae, which respectively represent the sub-torques in the x direction and the y direction. For example,

$${τ}_{1} = {k}_{p 1} ( {a}_{1}^{r e f} - {a}_{1} ) + {k}_{d 1} ( {\dot{a}}_{1}^{r e f} - {\dot{a}}_{1} ) + {k}_{i 1} {\int }_{{t}_{s}}^{{t}_{f}} ( {a}_{1}^{r e f} - {a}_{1} ) dt ;$$

$${τ}_{2} = {k}_{p 2} ( {a}_{2}^{r e f} - {a}_{2} ) + {k}_{d 2} ( {\dot{a}}_{2}^{r e f} - {\dot{a}}_{2} ) + {k}_{i 2} {\int }_{{t}_{s}}^{{t}_{f}} ( {a}_{2}^{r e f} - {a}_{2} ) dt ;$$

where, τ₁ represents a control torque applied in a roll angle direction of rotation in the y direction, a₁ represents an angle of rotation in the y direction, \dot{a}₁ represents an angular velocity of rotation in the y direction; and a₁^{ref} and \dot{a}₁^{ref} represent an expected angle and an expected angular velocity of rotation of the robotic arm in the y direction. τ₂ represents a control torque applied in a roll angle direction of rotation in the x direction, a₂ represents an angle of rotation in the x direction, \dot{a}₂ represents an angular velocity of rotation in the x direction; and a₂^{ref} and a₂^{ref} represent an expected angle and an expected angular velocity of rotation of the robotic arm in the x direction.

kₚ₁, k_{d1}, and kᵢ₁ respectively represent the proportional control parameter, the differential control parameter, and the integral control parameter, kₚ₂, k_{d2}, and kᵢ₂ respectively represent the proportional control parameter, the differential control parameter, and the integral control parameter, and tₛ and t_{f} respectively represent a start moment and a finish moment.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm, that is, the PID controller determines the first control signal according to the first actual posture of the robotic arm and the motion trajectory information of the three-dimensional object, and controls the robotic arm to catch the thrown three-dimensional object at any position other than the end. Therefore, a method for controlling a robotic arm to throw and catch a three-dimensional object at any position other than an end and maintain the balance of the three-dimensional object is developed.

Next, the action of re-balancing the three-dimensional object of the robotic arm is described.

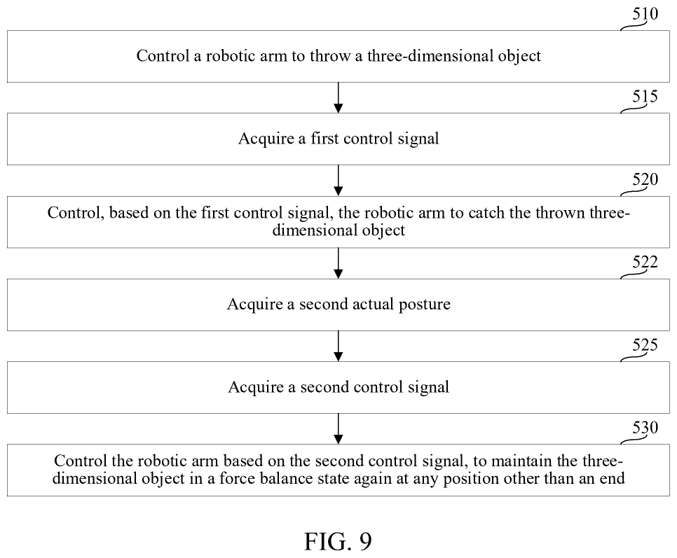

FIG. 9 is a flowchart of a robotic arm control method according to an embodiment of this application. The method may be performed by a controller of a robotic arm. That is, based on the embodiment shown in FIG. 4, the method further includes operation 522.

Operation 522: Acquire a second actual posture.

In one embodiment, the second actual posture is configured to indicate contact information of the robotic arm and the three-dimensional object. The contact information is configured for indicating an interaction between the robotic arm and the three-dimensional object, for example, at least one of features such as a mechanics feature and a position feature. A description is made by taking the position feature as one embodiment, the second actual posture is at least one of information such as a contact position between the robotic arm and the three-dimensional object, and a velocity and an acceleration at the contact position. In one embodiment, there is at least one of a contact point, a contact line, and a contact surface between the robotic arm and the three-dimensional object. In an embodiment, a method for recording the contact information is not limited in this embodiment. A coordinate system may be constructed by taking the robotic arm as a reference object to indicate the contact information, or a natural coordinate system may be constructed by taking the ground as a reference object, or a coordinate system may be constructed in another manner. In one embodiment, the second control signal is determined according to the second actual posture and a second expected posture. The second control signal is determined for the robotic arm according to the second actual posture and the second expected posture. In one embodiment, the second expected posture is configured to indicate posture information of the robotic arm re-balancing the three-dimensional object on the robotic arm. In some embodiments, the second expected posture is configured to indicate a velocity of the three-dimensional object. If the second expected posture is 0, it may be understood as that the three-dimensional object is expected to be in a static balance state, and the three-dimensional object is stationary on the robotic arm. If the second expected posture is not 0, it may be understood as that the three-dimensional object is expected to be in a dynamic balance state, and the three-dimensional object moves or rolls on the robotic arm without falling.

In some embodiments, the robotic arm control method provided in the embodiments of this application is implemented by a PID controller. In one embodiment, according to the second control signal, the robotic arm is controlled to re-balance the three-dimensional object at any position other than the end.

After the second control signal is determined, the robotic arm may be controlled according to the second control signal.

Further, the second control signal may be a control signal for one or more rotation axes. The second control signal is usually configured to control motions of the robotic arm by controlling a torque. Refer to FIG. 8. The second control signal may be configured to control the robotic arm to rotate about at least one rotation axis in the x direction, the y direction, or the z direction.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm, that is, determines the second control signal according to the second actual posture and the second expected posture of the robotic arm, and controls the robotic arm to re-balance the three-dimensional object at any position other than the end. Therefore, a method for controlling a robotic arm to throw and catch a three-dimensional object at any position other than an end and maintain the balance of the three-dimensional object is developed.

In one embodiment, the robotic arm control method is performed by a controller of a robotic arm. That is, in the embodiment shown in FIG. 9, operation 525 may be implemented as sub-operation 21.

Sub-operation 21: Determine a second control signal according to a difference between a second actual posture and a second expected posture.

In one embodiment, the second expected posture is configured to indicate posture information of the robotic arm re-balancing the three-dimensional object on the robotic arm. For the second actual posture and the second expected posture, refer to the foregoing descriptions. The second control signal is information configured to control the robotic arm to re-balance the three-dimensional object at any position other than the end.

In one embodiment, the second actual posture includes position information of a center of mass of the three-dimensional object in a direction of a second rotation axis and an offset velocity of the three-dimensional object in the direction of the second rotation axis. Correspondingly, the second expected posture includes an expected position of the center of mass of the three-dimensional object in the direction of the second rotation axis and an expected velocity of the three-dimensional object in the direction of the second rotation axis, and the second control signal includes a second control torque. In one embodiment, the second expected posture is preset posture information of the robotic arm re-balancing the three-dimensional object at any position other than the end. In one embodiment, the difference between the second actual posture and the second expected posture is configured to indicate a difference between a current actual posture and a posture of the robotic arm re-balancing the three-dimensional object on the robotic arm. The difference is configured to indicate that the second control signal is determined by taking the current actual posture as a reference, and taking the second expected posture as a motion target. The second control signal is configured to control the robotic arm to move to the second expected posture by taking the current actual posture as a reference. In one embodiment, the second control signal is determined based on a product of a control parameter and the foregoing difference.

In one embodiment, this operation may be implemented as the following sub-operations.

The second control torque is determined according to a difference between the position information and the expected position, and a difference between the offset velocity and the expected velocity.

The second control torque is configured to indicate a torque applied in a roll angle direction of rotation of the robotic arm about the second rotation axis, and the second rotation axis is a horizontal line perpendicular to the robotic arm; and/or the second control torque is configured to indicate a torque applied in a pitch angle direction of rotation of the robotic arm about the second rotation axis, and the second rotation axis is an extension line of the robotic arm. Refer to FIG. 8. The second rotation axis is the x direction and/or the y direction in FIG. 8. In one embodiment, there is a third difference between the position information and the expected position, and there is a fourth difference between the offset velocity and the expected velocity. A sum of a fourth product and a fifth product is determined as the second control torque. The fourth product is a product of the third difference value and a fourth control parameter, and the fourth control parameter is also referred to as a proportional control parameter. The fifth product is a product of the fourth difference and a fifth control parameter, and the fifth control parameter is also referred to as a differential control parameter. Further, a sum of the fourth product, the fifth product, and a sixth product is determined as the second control torque. The sixth product is a product of an integration calculation result of the third difference and a sixth control parameter, and the sixth control parameter is also referred to as an integral control parameter.

Specifically, the robotic arm control method provided in the embodiments of this application is performed by the PID controller, and a control signal is further determined according to at least one of the proportional control parameter, the differential control parameter, and the integral control parameter. According to the control principle of the PID controller, a description is made by using one embodiment in which the second control signal is the second control torque, the PID controller may be implemented by using the following formula:

$$τ = {k}_{p} ( {y}^{r e f} - y ) + {k}_{d} ( {\dot{y}}^{r e f} - \dot{y} ) + {k}_{i} {\int }_{{t}_{s}}^{{t}_{f}} ( {y}^{r e f} - y ) dt ;$$

where, τ represents the second control torque, y represents the position information of the center of mass of the three-dimensional object in the direction of the second rotation axis in the second actual posture, \dot{y} represents the offset velocity of the three-dimensional object in the direction of the second rotation axis in the second actual posture, y is a first-order derivative of y about time, y^{ref} and \dot{y}^{ref} represent the second expected posture, and specifically, the expected position of the center of mass of the three-dimensional object in the direction of the second rotation axis and the expected velocity of the three-dimensional object in the direction of the second rotation axis that are included in the second expected posture, kₚ, k_{d}, and kᵢ respectively represent the proportional control parameter, the differential control parameter, and the integral control parameter, and tₛ and t_{f} respectively represent a start moment and a finish moment of the second control torque.

In addition, in one embodiment, the second control torque is configured to control the robotic arm in the x direction and the y direction in FIG. 8, respectively. For example, the second control torque includes two sub-torques, which are configured to respectively control the robotic arm in the foregoing two directions. The formula of the second control torque may be implemented as the following two formulae, which respectively represent the sub-torques in the x direction and the y direction. For example,

$${τ}_{1} = {k}_{p 1} ( {y}_{1}^{r e f} - {y}_{1} ) + {k}_{d 1} ( {\dot{y}}_{1}^{r e f} - {\dot{y}}_{1} ) + {k}_{i 1} {\int }_{{t}_{s}}^{{t}_{f}} ( {y}_{1}^{r e f} - {y}_{1} ) dt ;$$

$${τ}_{2} = {k}_{p 2} ( {y}_{2}^{r e f} - {y}_{2} ) + {k}_{d 2} ( {\dot{y}}_{2}^{r e f} - {\dot{y}}_{2} ) + {k}_{i 2} {\int }_{{t}_{s}}^{{t}_{f}} ( {y}_{2}^{r e f} - {y}_{2} ) dt ;$$

where, τ₁ represents a control torque applied in a roll angle direction of rotation in the y direction, y₁ represents position information of the center of mass of the three-dimensional object in the y direction, y₁ represents an offset velocity of the center of mass of the three-dimensional object in the y direction, and y₁^{ref} and \dot{y}₁^{ref} represent an expected position and an expected velocity of the center of mass of the three-dimensional object in the y direction.

τ₂ represents a control torque applied in a roll angle direction of rotation in the x direction, y₂ represents position information of the center of mass of the three-dimensional object in the x direction, \dot{y}₂ represents an offset velocity of the center of mass of the three-dimensional object in the x direction, and y₂^{ref} and \dot{y}₂^{ref} represent an expected position and an expected velocity of the center of mass of the three-dimensional object in the x direction.

kₚ₁, k_{d1}, and kᵢ₁ respectively represent the proportional control parameter, the differential control parameter, and the integral control parameter, kₚ₂, k_{d2}, and kᵢ₂ respectively represent the proportional control parameter, the differential control parameter, and the integral control parameter, and tₛ and t_{f} respectively represent a start moment and a finish moment. In addition, in this embodiment, for ease of presentation, the parameter symbols of the proportional control parameter, the differential control parameter, the integral control parameter, and the start and finish moments are the same as those in the formulae in sub-operation 11, but the parameters are valued independently of each other and usually have different values.

In some embodiments, it is determined, according to state estimation of the robotic arm and the three-dimensional object, that the three-dimensional object is in a relatively stable state on the robotic arm. For example, a contact position between the robotic arm and the three-dimensional object is close to a center of gravity of the robotic arm, and the center of mass of the three-dimensional object is also close to the center of gravity of the robotic arm. For another example, a difference between coordinates of the contact position between the robotic arm and the three-dimensional object and coordinates of the center of gravity of the robotic arm is less than a first threshold, and a difference between coordinates of the center of mass of the three-dimensional object and the coordinates of the center of gravity of the robotic arm is less than a second threshold. The first threshold and the second threshold are set according to actual requirements, and are not limited in this application.

In this case, if the three-dimensional object is expected to be in balance on the robotic arm, y₁^{ref}=0. If the three-dimensional object is expected to be in a static balance state on the robotic arm, \dot{y}₁^{ref}=0. If the center of mass of the three-dimensional object is expected to be as close as possible to the center of gravity of the robotic arm in the direction of the y axis, y₂ref=0. If a moving velocity of the center of mass of the three-dimensional object in the direction of the y axis is expected to be as small as possible, \dot{y}₂ref=0. According to the second control torque obtained in this manner, the robotic arm remains the three-dimensional object to be in the static balance state on the robotic arm, which may also be understood as that the three-dimensional object is stationary relative to the robotic arm.

In some other embodiments, it is determined, according to state estimation of the robotic arm and the three-dimensional object, that the three-dimensional object is in a relatively unstable state on the robotic arm. For example, the contact position between the robotic arm and the three-dimensional object is away from the center of gravity of the robotic arm, and/or the center of mass of the three-dimensional object is also away from the center of gravity of the robotic arm. Specifically, the relatively unstable state of the three-dimensional object on the robotic arm is configured to indicate that the difference between the coordinates of the contact position between the robotic arm and the three-dimensional object and the coordinates of the center of gravity of the robotic arm is not less than the first threshold, and/or the difference between the coordinates of the center of mass of the three-dimensional object and the coordinates of the center of gravity of the robotic arm is not less than the second threshold. The first threshold and the second threshold may be set according to actual requirements, and are not limited in this application.

In this case, a value may be assigned to expected posture information according to a state estimation result. The assigned value may be 0, or may be a value other than 0. According to the second control torque obtained in this manner, the robotic arm remains the three-dimensional object in the dynamic balance state on the robotic arm, which may also be understood as that the three-dimensional object moves or rolls on the robotic arm without falling. In one embodiment, in a case that the three-dimensional object is in the relatively unstable state on the robotic arm, the assigned value of the expected posture information is not equal to 0. In a case that the three-dimensional object is not in the relatively unstable state on the robotic arm, the assigned value of the expected posture information is 0. In addition, in a case that the three-dimensional object is in the relatively unstable state on the robotic arm, the contact position between the robotic arm and the three-dimensional object is away from the center of gravity of the robotic arm, and/or the center of mass of the three-dimensional object is also away from the center of gravity of the robotic arm. That is, the three-dimensional object is located on a side of the robotic arm.

However, in a process of controlling motions of the robotic arm to re-balance the three-dimensional object, the contact position between the robotic arm and the three-dimensional object approaches the center of gravity of the robotic arm, and the center of mass of the three-dimensional object approaches the center of gravity of the robotic arm. This helps the robotic arm maintain a small velocity relative to the three-dimensional object. In a case that the three-dimensional object is in the relatively unstable state on the robotic arm, the assigned value of the expected posture information is not equal to 0, whereby the three-dimensional object is balanced quickly, and efficiency of controlling the robotic arm based on the second control signal, to maintain the three-dimensional object in a force balance state again is improved.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm, that is, the PID controller determines the second control signal according to the second actual posture and the second expected posture of the robotic arm, and controls the robotic arm to re-balance the three-dimensional object at any position other than the end. Therefore, a method for controlling a robotic arm to throw and catch a three-dimensional object at any position other than an end and maintain the balance of the three-dimensional object is developed.

Next, acquisition of the second actual posture is further described through several embodiments. The second actual posture is acquired based on a visual sensor, or acquired based on the visual sensor and a tactile sensor.

In one embodiment, for deployment positions of the visual sensor and the tactile sensor, the visual sensor is arranged on the robotic arm, or arranged outside the robotic arm; and the tactile sensor is arranged on a housing of the robotic arm and may serve as an electronic skin of the robotic arm. For example, a joint motor coder is mounted on a joint motor of the robotic arm and is configured to feed back a rotation angle, an angular velocity, and current information of each joint. The information may be configured for state estimation of the robotic arm. For another example, the tactile sensor is arranged on a finger, a palm, and a link of the robotic arm and is configured to acquire feedback information of the three-dimensional object. In some embodiments, the second actual posture is acquired by using a proximity sensor. The proximity sensor is configured to transmit a signal when two objects approach, and when the three-dimensional object approaches the proximity sensor, the second actual posture may be obtained according to the signal. In one embodiment, for the case that the second actual posture includes the position information of the center of mass of the three-dimensional object in the direction of the second rotation axis, the proximity sensors are deployed on the three-dimensional object and a rotatable joint of the robotic arm. The position information of the center of mass of the three-dimensional object in the direction of the second rotation axis is obtained by subtracting a distance between an outer surface, where the sensor is deployed, of the three-dimensional object and the center of mass from a signal transmitted by the proximity sensor, to acquire the second actual posture.

In one embodiment, this application proposes the following three alternative implementations for acquiring the second actual posture.

Implementation 1: Full-degree-of-freedom posture recognition of a three-dimensional object based on visual perception.

The robotic arm with 7 degrees of freedom shown in FIG. 1 to FIG. 3 is taken as one embodiment. In the related art, 6-degree-of-freedom posture recognition of the three-dimensional object may be achieved by using a visual sensor, to determine a relative position relationship between the three-dimensional object and the robotic arm, and further, to determine the second actual posture. In one embodiment, image information of the robotic arm and the three-dimensional object in six directions on three coordinate axes in a three-dimensional coordinate system is acquired, and a relative position relationship between the three-dimensional object and the robotic arm that is carried in the image information is extracted. In some embodiments, because the implementation relies on obtaining image information in six directions, a large volume of data needs to be processed during posture recognition, and operating time of posture recognition is approximately 100 milliseconds, namely, 10 Hz.

Implementation 2: Data image processing based on a visual sensor.

In one embodiment, this implementation corresponds to that in the embodiment shown in FIG. 9, operation 522 may be implemented as sub-operation 25.

Sub-operation 25: Acquire a second actual posture based on a visual sensor.

In one embodiment, the second actual posture is obtained by performing data image processing on image information, the visual sensor is configured to acquire the image information, and the second actual posture is configured to indicate a position of the three-dimensional object in a dynamic system. In an embodiment, a lightweight data image processing method is applied to determine the position of the three-dimensional object in the dynamic system, namely, the second actual posture. The dynamic system provides a reference system for describing the second actual posture. For example, a camera is arranged on the robotic arm or in an external environment, to acquire image information of the robotic arm and the three-dimensional object. The image information is configured for displaying that the three-dimensional object is placed on the robotic arm. Subsequently, the image information is analyzed and processed, to obtain an image processing result, and the position of the three-dimensional object in the dynamic system is extracted. In one embodiment, after the image information is acquired, cluster analysis is performed on at least one type of information such as colors, materials, surface textures, and connected areas of the three-dimensional object and an object in an environment. The three-dimensional object and the robotic arm are isolated based on a difference between at least one type of information such as colors, materials, surface textures, and connected areas of the three-dimensional object and the robotic arm. A geometric center of the three-dimensional object is determined according to a shape of the three-dimensional object, and then, positions of the geometric center and the center of mass in the dynamic system may be determined. Based on this, the second actual posture may be obtained with reference to related information of the robotic arm. For example, coordinates and a moving velocity of the contact position are determined according to the geometric center of the three-dimensional object, and an offset and an offset velocity are determined according to the position of the center of mass of the three-dimensional object. In some embodiments, an operating speed of lightweight calculation in this implementation is relatively fast, and operating time is approximately 10 milliseconds, namely, 10 Hz.

Based on this, in an embodiment, sub-operation 25 is implemented as follows:

The image information is acquired by using the visual sensor, and the image information is configured for displaying that the three-dimensional object is placed on the robotic arm.

The second actual posture is determined according to the image processing result obtained through image information processing.

In one embodiment, the second actual posture includes the position information of the center of mass of the three-dimensional object in the direction of the second rotation axis and the offset velocity of the three-dimensional object in the direction of the second rotation axis. The image processing result obtained through image information processing is configured to indicate a relative position relationship between the three-dimensional object and the robotic arm, and the image processing result directly carries the position information of the center of mass of the three-dimensional object in the direction of the second rotation axis. Further, the image processing result includes positions of the three-dimensional object at two timestamps, a quotient of the position of the three-dimensional object and a time difference is determined as the offset velocity of the three-dimensional object in the direction of the second rotation axis, and the time difference is a time difference between the two timestamps included in the image processing result.

Implementation 3: Data fusion based on a visual sensor and a tactile sensor.

In one embodiment, this implementation corresponds to that in the embodiment shown in FIG. 9, operation 522 may be implemented as sub-operation 26.

Sub-operation 26: Acquire a second actual posture based on a visual sensor and a tactile sensor.

Sub-operation 25 or sub-operation 26 is performed, and the two-sub-operations cannot be simultaneously performed.

In some embodiments, the second actual posture is obtained based on the visual sensor and the tactile sensor. For processing of the visual sensor, refer to the foregoing content, and for processing of the tactile sensor, refer to the following content.

According to the foregoing content, in a case that the lightweight data image processing method is applied, a relatively large error may exist in a depth direction (that is, the direction of the y axis shown in FIG. 8) of a camera. Based on this, the tactile sensor may be configured to compensate for the error. For example, the tactile sensor is arranged on the housing of the robotic arm, to collect a corresponding tactile signal when the three-dimensional object is placed on the robotic arm. Based on this, a specific position of the three-dimensional object in the y direction of the robotic arm can be accurately obtained.

That is, sub-operation 26 may be implemented as follows: first information of the three-dimensional object in a first direction is determined based on the visual sensor; second information of the three-dimensional object in a second direction is determined based on the tactile sensor; and the first information and the second information are fused, to obtain the second actual posture. The first direction is a direction of a horizontal line perpendicular to the robotic arm, and the second direction is a direction of an extension line of the robotic arm. For determination of the first information, refer to the foregoing content. Details are not described herein again. Determination of the second information and fusion are described below. In one embodiment, the tactile sensor is arranged on the housing of the robotic arm and may serve an electronic skin of the robotic arm. A position and a pitch angle posture of the three-dimensional object in the y direction are recorded in contact information of the three-dimensional object and the robotic arm that is collected by the tactile sensor. In addition, with reference to lightweight image processing of the visual sensor, the specific position of the three-dimensional object in the y direction of the robotic arm may be determined through comparison with prior picture data.

In some embodiments, operating time of the tactile sensor in this implementation is approximately 10 milliseconds, namely, 10 Hz. With reference to the foregoing content, a comparison of the three implementations is provided, as shown in the following table:

| Solution | Operating period | | Linear error | | Angle error |
|---|---|---|---|---|---|
| Implementation 1 | 100 | ms | 1-2 | cm | 5-10° |
| Implementation 2 | 10 | ms | 1 | cm | 5° |
| Implementation 3 | 10 | ms | 1 | cm | 5° |

The position of the three-dimensional object on the robotic arm that is determined by Implementation 1 has a linear error of 1 to 2 centimeters and an angle error of 5 to 10 degrees, that is, the obtained second actual posture has a linear error and an angle error. Similarly, Implementation 2 and Implementation 3 also lead to errors. Still further, Implementation 3 is an improved implementation based on Implementation 2, and can overcome a disadvantage of inaccurate measurement for the center of mass in the direction of the y axis of Implementation 2, whereby an error of the obtained second actual posture is smaller.

If the robotic arm control method provided in this application is adopted, an appropriate implementation may be selected according to actual requirements, to acquire the second actual posture. This is not limited in this application. Refer to the foregoing content. Sub-operation 26 may be implemented as follows: the first information of the three-dimensional object in the first direction is determined based on the visual sensor; the second information of the three-dimensional object in the second direction is determined based on the tactile sensor; and the first information and the second information are fused, to obtain the second actual posture.

In an embodiment, determination of the second information is specifically implemented as follows: position information of a contact point between the three-dimensional object and the robotic arm relative to the robotic arm is determined by using the tactile sensor.

The position information determined in this manner at least includes coordinates of a contact position between the three-dimensional object and the robotic arm. For related content of for acquiring the position information by the tactile sensor, refer to the foregoing content. Details are not described herein again. In some embodiments, the tactile sensor is arranged on the housing of the robotic arm and configured to acquire the contact position between the three-dimensional object and the robotic arm.

Refer to the foregoing content. the first information is data of visual perception, and the second information is data of tactile perception. The foregoing two pieces of data may be fused. In an embodiment, fusion is performed by using any one or more of the following algorithms: a Kalman filtering (KF) algorithm, an extended Kalman filtering (EKF) algorithm, and a particle filter (PF) algorithm.

There is a plurality of implementations of data fusion. The foregoing content is merely one embodiment, and does not constitute a limitation on this application. In addition, as the fusion method is updated, fusion methods that are developed after this application are also applicable to this application, that is, a fusion result does not limit the robotic arm control method provided in this application.

In conclusion, according to the method provided in this embodiment, a method for using a robotic arm is provided. The robotic arm can first throw the three-dimensional object, catch the three-dimensional object at any position other than the end, and re-balance the three-dimensional object. The second actual posture is determined based on the visual sensor or based on the visual sensor and the tactile sensor. A plurality methods for acquiring the second actual posture are provided. Therefore, a method for controlling a robotic arm to throw and catch a three-dimensional object at any position other than an end and maintain the balance of the three-dimensional object is developed.

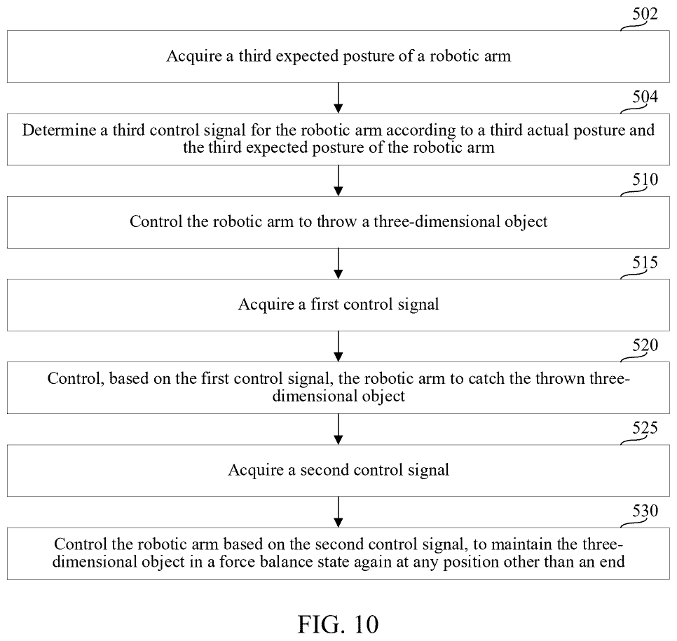

FIG. 10 is a flowchart of a robotic arm control method according to an embodiment of this application. The method may be performed by a controller of a robotic arm. That is, based on the embodiment shown in FIG. 4, the method further includes operation 502 and operation 504.

Operation 502: Acquire a third expected posture of a robotic arm.

In one embodiment, the third expected posture is configured to indicate posture information of the robotic arm that is separated from the three-dimensional object, to enable the three-dimensional object to obtain a vertical upward velocity. In one embodiment, the third expected posture indicates that the robotic arm lifts up in a pitch direction, to enable the three-dimensional object to obtain the vertical upward velocity.

Operation 504: Determine a third control signal for the robotic arm according to a third actual posture and the third expected posture of the robotic arm.

In one embodiment, the third expected posture is configured to indicate the posture information of the robotic arm that is separated from the three-dimensional object, to enable the three-dimensional object to obtain the vertical upward velocity. The third control signal is configured to control the robotic arm to move from the third actual posture to the third expected posture. In some embodiments, the robotic arm control method provided in the embodiments of this application is implemented by a PID controller. In one embodiment, the third expected posture may be implemented as a posture sequence, such as a time sequence changing with time. In one embodiment, a difference between the third actual posture and the third expected posture is configured to indicate a difference between a current actual posture and a posture of the robotic arm separating the three-dimensional object from the robotic arm. The difference is configured to indicate that the third control signal is determined by taking the current actual posture as a reference, and taking the third expected posture as a motion target.

In one embodiment, the third actual posture includes an angle and an angular velocity of rotation of the robotic arm about a rotation axis. Correspondingly, the third expected posture includes an expected angle and an expected angular velocity of rotation of the robotic arm about the rotation axis. Refer to FIG. 8. The rotation axis may be at least one rotation axis in the x direction, the y direction, or the z direction. For a specific method for determining the third control signal for the robotic arm, refer to the formulae of the PID controller in sub-operation 12. In one embodiment, the third expected posture includes that within a first time period (such as 0.1 s), values of a joint angle 4 and a joint angle 5 (elbow joints of a forearm) are decreased from an initial value of a preparatory posture to 0 degree, a joint angle 3 is moved from 1.57 radians to 1.37 radians, and values of other joint angles remain unchanged. The third control signal is determined according to the third actual posture and the third expected posture with reference to the formulae of the PID controller in sub-operation 12.

In one embodiment, according to the third control signal, the robotic arm is controlled to throw the three-dimensional object.

After the third control signal is determined, the robotic arm may be controlled according to the third control signal. The third control signal is configured to control the robotic arm to move to the third expected posture by taking the current actual posture as a reference. By controlling robotic arm to move, the three-dimensional object is separated from the robotic arm. Further, the third control signal may be a control signal for one or more rotation axes. The third control signal is usually configured to control motions of the robotic arm by controlling a torque. Even if the third control signal is configured to control the robotic arm to enable the three-dimensional object to obtain the vertical upward velocity, the case that the three-dimensional object obtains a velocity component in any direction on a plane perpendicular to the vertical direction is not excluded. Specifically, in a case that a first arm throws up the three-dimensional object, and a second arm catches the thrown three-dimensional object at any position other than an end, the three-dimensional object obtains a velocity component in any direction on the plane perpendicular to the vertical direction, and according to the velocity component, the three-dimensional object is thrown up by the first arm and moves toward the second arm. Accordingly, the second arm catches the three-dimensional object in the air. Refer to FIG. 8. The third control signal may be a control signal for at least one rotation axis in the x direction, the y direction, or the z direction.

In an alternative implementation, before operation 512, the method further includes the following operations: a fourth expected posture of the robotic arm is acquired; and a fourth control signal is determined for the robotic arm according to a fourth actual posture and the fourth expected posture of the robotic arm.

In one embodiment, the fourth expected posture is configured to indicate posture information of the robotic arm that is in contact with the three-dimensional object and obtains a vertical downward velocity. In one embodiment, before the robotic arm is separated from the three-dimensional object, to enable the three-dimensional to obtain the vertical upward velocity, the robotic arm obtains the vertical downward velocity, which enables the robotic arm to obtain moving space, and enables the three-dimensional object to obtain an increased vertical upward velocity. The fourth expected posture includes an expected angle and an expected angular velocity of rotation of the robotic arm about the rotation axis. Similarly, the fourth expected posture may be implemented as a posture sequence, such as a time sequence changing with time. In one embodiment, a difference between the fourth actual posture and the fourth expected posture is configured to indicate a difference between a current actual posture and a posture of the robotic arm that is in contact with the three-dimensional object and obtains the vertical downward velocity. The difference is configured to indicate that the fourth control signal is determined by taking the current actual posture as a reference, and taking the fourth expected posture as a motion target. The fourth control signal is configured to control the robotic arm to move to the fourth expected posture by taking the current actual posture as a reference. By controlling the robotic arm to move, the three-dimensional object is in contact with the robotic arm, and the robotic arm obtains the vertical downward velocity.

For a specific method for determining the fourth control signal for the robotic arm, refer to the formulae of the PID controller in sub-operation 12. In one embodiment, the fourth expected posture includes that within a second time period (such as 0.2 s), values of a joint angle 4 and a joint angle 5 (elbow joints of the forearm) are increased from 0 degree to a value (such as 0.5 radians) greater than an initial value of a preparatory posture, a joint angle 1 is rotated from an initial angle to a preset value (such as 0.3 radians), a joint angle 3 is moved from 1.37 radians to 1.17 radians, and values of other joint angles remain unchanged. The fourth control signal is determined according to the fourth actual posture and the fourth expected posture with reference to the formulae of the PID controller in sub-operation 12. In addition, the foregoing joint angles are determined based on the robotic arm with 7 degrees of freedom in FIG. 1, that is, an included angle between two movable members of a shoulder joint upper arm is the joint angle 1, and an included angle between two movable members at the end of the robotic arm is a joint angle 7. Joint angles in the following descriptions are all determined based on the robotic arm with 7 degrees of freedom in FIG. 1, and are not further described below.

Operation 510 may be implemented as follows: the robotic arm is controlled to throw the three-dimensional object according to the third control signal and the fourth control signal.

In one embodiment, the third control signal is configured to control the robotic arm to be separated from the three-dimensional object, to enable the three-dimensional object to obtain the vertical upward velocity. The fourth control signal is configured to control the robotic arm to be in contact with the three-dimensional object and obtain the vertical downward velocity. In one embodiment, first, the robotic arm is controlled, according to the fourth control signal, to be in contact with the three-dimensional object and obtain the vertical downward velocity; and then, the robotic arm is controlled, according to the third control signal, to be separated from the three-dimensional object, to enable the three-dimensional object to obtain the vertical upward velocity. Accordingly, when the three-dimensional object is separated from the robotic arm, the three-dimensional object is thrown up at an increased velocity. In one embodiment, first, the fourth control signal controls the robotic arm to move to the fourth expected posture by taking the current actual posture as a reference. After the robotic arm moves to the fourth expected posture, the third control signal controls the robotic arm to move to the third expected posture by taking the current actual posture as a reference. By controlling the robotic arm to move, the three-dimensional object is separated from the robotic arm. In one embodiment, the action of throwing up the three-dimensional object of the robotic arm is implemented as follows: first, the robotic arm is controlled, according to the fourth control signal, to be in contact with the three-dimensional object and obtain the vertical downward velocity, and then, the robotic arm is controlled, according to the third control signal, to be separated from the three-dimensional object, to enable the three-dimensional object to obtain the vertical upward velocity.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm, that is, determines the third control signal according to the third actual posture and the third expected posture of the robotic arm, and controls the robotic arm to throw the three-dimensional object. Therefore, a method for controlling a robotic arm to throw and catch a three-dimensional object at any position other than an end and maintain the balance of the three-dimensional object is developed.

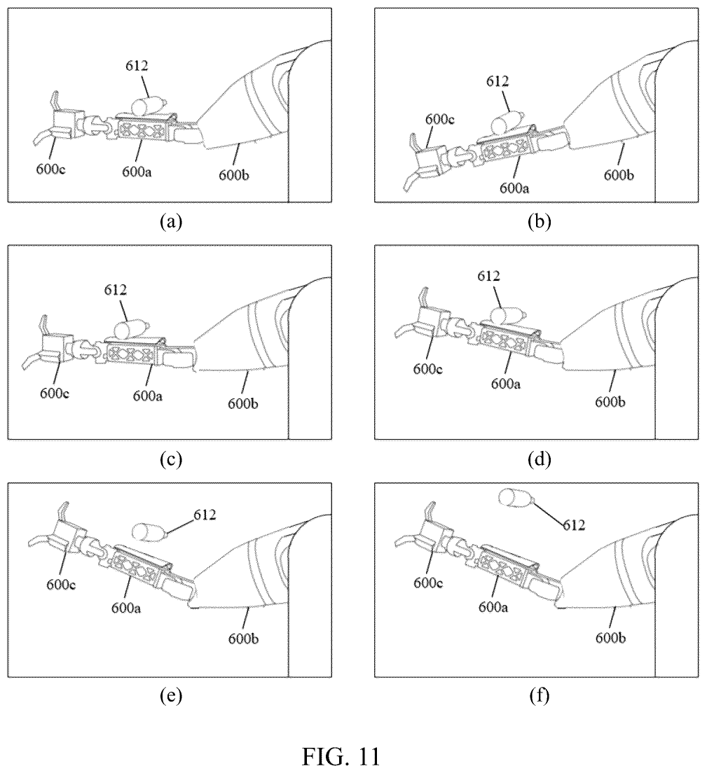

FIG. 11 is a schematic diagram of a robotic arm and a three-dimensional object according to an embodiment of this application. FIG. 11 includes a sub-graph a to a sub-graph f, which show six timestamps in a process in which the robotic arm throws up a three-dimensional object 612. In one embodiment, in sub-graph a, the three-dimensional object 612 is placed on a forearm 600a of the robotic arm, and the robotic arm further includes an upper arm 600b of the robotic arm. For descriptions about the forearm arm and the upper arm of the robotic arm, refer to the related descriptions to sub-operation 16b, operation 604, and FIG. 3, which are not shown herein again. In sub-graph b, the forearm 600a performs pitching motion, and rotates about an elbow joint, to lower an end 600c of the robotic arm. In sub-graph c, the forearm 600a of the robotic arm performs pitching motion, and rotates about the elbow joint, to lift the end 600c of the robotic arm. In sub-graph d, the forearm 600a of the robotic arm rotates about the elbow joint, and the upper arm 600b of the robotic arm rotates about a shoulder joint, to further lift the end 600c of the robotic arm. In one embodiment, sub-graph d corresponds to a timestamp before the three-dimensional object 612 is separated from the robotic arm. In sub-graph e, the three-dimensional object 612 is separated from the robotic arm, and the three-dimensional object 612 is thrown up. In sub-graph f, the three-dimensional object 612 reaches a highest point.

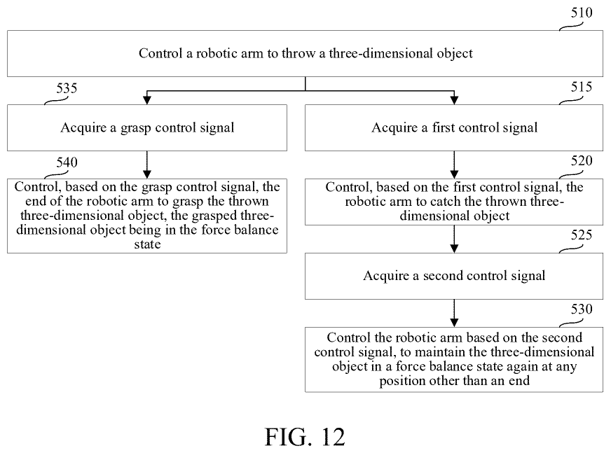

FIG. 12 is a flowchart of a robotic arm control method according to an embodiment of this application. The method may be performed by a controller of a robotic arm. That is, based on the embodiment shown in FIG. 4, the method further includes operation 535 and operation 540.

Operation 535: Acquire a grasp control signal.

In one embodiment, the grasp control signal is configured to control the end of the robotic arm to grasp the three-dimensional object. In an embodiment, the grasp control signal controls the robotic arm to move with reference to the motion trajectory information of the three-dimensional object. Further, the end of the robotic arm may be stationary relative to the three-dimensional object. Moreover, the end of the robotic arm is controlled to close, and the three-dimensional object is grasped by using a robotic hand deployed at the end of the robotic arm. Similar to the first control signal, a method for acquiring the grasp control signal is not limited in this application.

Operation 540: Control, based on the grasp control signal, the end of the robotic arm to grasp the thrown three-dimensional object, the grasped three-dimensional object being in the force balance state.

In one embodiment, the end of the robotic arm performs prehensile manipulation on the three-dimensional object. The end of the robotic arm is a robotic hand that can open or close. The three-dimensional object reaches the force balance state, and the end of the robotic arm grasps the three-dimensional object, to form at least one of form closure and force closure for the three-dimensional object. Further, prehensile manipulation restricts motions of the three-dimensional object. Through contact between the end of the robotic arm and the three-dimensional object, the three-dimensional object is stationary relative to the end of the robotic arm, or the three-dimensional object moves relative to the robotic arm but is not separated from the end of the robotic arm. In one embodiment, the grasp control signal is configured to control the robotic arm to move by taking a current actual posture as a reference. Accordingly, a motion target of controlling the end of the robotic arm to grasp the thrown three-dimensional object is achieved.

In one embodiment, before operation 540, the method further includes the following operation: the motion trajectory information of the three-dimensional object is acquired.

In one embodiment, the grasp control signal is determined according to the first actual posture of the robotic arm and the motion trajectory information of the three-dimensional object. In one embodiment, the grasp control signal is determined for the end of the robotic arm according to the first actual posture of the robotic arm and the motion trajectory information of the three-dimensional object; and the end of the robotic arm is controlled, according to the grasp control signal, to grasp the three-dimensional object.

In one embodiment, for a method for acquiring the motion trajectory information, refer to operation 522. Details are not described herein again. The motion trajectory information is a parabolic trajectory of the three-dimensional object after the three-dimensional object is separated from the robotic arm. The grasp control signal is configured to control the end of the robotic arm to grasp the three-dimensional object. The first actual posture of the robotic arm is configured to indicate posture and position information of the robotic arm at a current timestamp. For example, the posture information is described by using at least one of an angle and an angular velocity of the robotic arm.

The grasp control signal includes information that instructs the robotic arm to move with reference to the motion trajectory information of the three-dimensional object, and controls motion of performing prehensile manipulation on the three-dimensional object of the end of the robotic arm. In one embodiment, for the information that instructs the robotic arm to move with reference to the motion trajectory information of the three-dimensional object, refer to operation 524. A control signal configured to control the motion of performing prehensile manipulation on the three-dimensional object of the end of the robotic arm is determined according to a shape feature of the three-dimensional object. For example, the control signal configured to control the robotic arm to perform prehensile manipulation is determined according to information such as a size or a radian of the three-dimensional object. In some embodiments, the robotic arm control method provided in the embodiments of this application is implemented by a PID controller. For a specific implementation, refer to operation 12.

In conclusion, according to the method provided in this embodiment, a method for using a robotic arm is provided. The robotic arm can first throw the three-dimensional object, and then grasp the three-dimensional object with the end. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

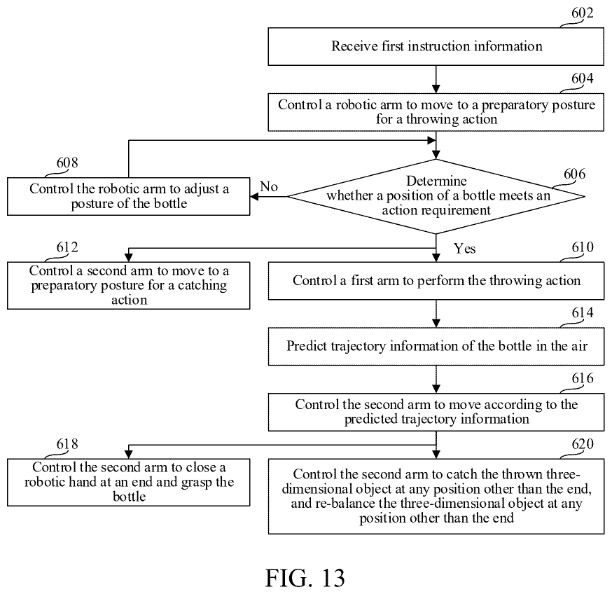

FIG. 13 is a flowchart of a robotic arm control method according to an embodiment of this application. The method may be performed by a controller of a robotic arm. The method includes:

Operation 602: Receive first instruction information.

In one embodiment, in a case that the first instruction information is not received, the robotic arm continuously waits for a user instruction in a preset instruction preparatory posture. The first instruction information may be transmitted by an input device such as a voice, a gesture, a keyboard, or a remote control. The first instruction information may be obtained through AI-based cluster analysis and pattern recognition of a voice and a gesture, or may be obtained through instruction signal transmission and parsing.

The first instruction information is configured for instructing the robotic arm to throw a three-dimensional object (such as a bottle) and then catch the thrown three-dimensional object in the air.

Operation 604: Control a robotic arm to move to a preparatory posture for a throwing action.

The robotic arm is controlled to move to a preparatory posture in which a forearm throws a bottle, and the preparatory posture is a preset posture of the robotic arm. In one embodiment, the preparatory posture is convenient for the forearm to start the action of throwing the bottle at any time, and is a safe and stable posture for the robotic arm.

Specifically, an initial posture may be set as that a first arm of a dual-robotic-arm platform straightens and points to the right front, at the same time, a joint 1 (a shoulder joint of an upper arm) moves downward, a joint 4 and a joint 5 (elbow joints of a forearm) move upward, a rigid body of the forearm remains substantially parallel to the ground, and a distance between the forearm and the ground is less than a distance between the shoulder joint and the ground.

Operation 606: Determine whether a position of a bottle meets an action requirement.

In one embodiment, in a case that the posture of the bottle does not meet the action requirement, operation 608 is performed; and in a case that the posture of the bottle meets the action requirement, operation 610 and operation 612 are performed.

In one embodiment, whether the posture of the bottle meets the action requirement is determined, and the action requirement is a requirement for a throwing action, which is obtained through planning in a dynamic model including the robotic arm and the bottle, or is preset. For example, the bottle is parallel to the ground, the bottle is perpendicular to the forearm of the robotic arm, a contact point between the bottle and the forearm is located at a side, close to the elbow joint, of an edge of the forearm, and the contact point between the bottle and the forearm is located at one-third of a side, close to the elbow joint, of the forearm.

Operation 608: Control the robotic arm to adjust a posture of the bottle in a case that the posture of the bottle does not meet the action requirement.

In one embodiment, after operation 608 is performed, operation 606 is performed, to re-determine whether the posture of the bottle meets the action requirement. In one embodiment, in a case that the posture of the bottle does not meet the action requirement, the robotic arm is controlled to move, to indirectly adjust the posture of the bottle until the posture of the bottle meets the action requirement.

Operation 610: Control a first arm to perform the throwing action in a case that the posture of the bottle meets the action requirement.

In one embodiment, in this embodiment, the description is made by taking the dual-robotic-arm platform as one embodiment. In another implementation, all operations in this embodiment are implemented by one robotic arm. In one embodiment, the first arm is controlled to perform the throwing action, the bottle placed on the forearm of the first arm obtains an upward velocity, has a velocity after being separated from an upper surface of the forearm, and continues to move upward. In a process in which the forearm is in contact with the bottle to interact with each other, that is, before the forearm is separated from the bottle, the bottle may slide on the forearm, does not fall off the upper surface of the forearm during sliding, and does not slide out of a front-rear range of the forearm due to an excessively large moving velocity and an excessively long moving distance. After being thrown in the air, the bottle may have a velocity in a forward direction of the forearm and a velocity in a direction from the first arm to a second arm, or may have an own rotation velocity of the bottle.

In a specific implementation, the throwing action performed by the first arm includes: starting from a preparatory posture of the robotic arm, within a first time period (such as 0.1 s), values of a joint angle 4 and a joint angle 5 (elbow joints of a forearm) are decreased from initial values of the preparatory posture to 0 degree, a joint angle 3 is moved from 1.57 radians to 1.37 radians, and values of other joint angles remain unchanged; and within a second time segment (such as 0.2 s), the values of the joint angle 4 and the joint angle 5 (the elbow joints of the forearm) are increased from 0 degree to values (such as 0.5 radians) greater than the initial values of the preparatory posture, a joint angle 1 is rotated from an initial angle to a preset value (such as 0.3 radians), the joint angle 3 is moved from 1.37 radians to 1.17 radians, and values of other joint angles remain unchanged.

Operation 612: Control a second arm to move to a preparatory posture for a grasp action in a case that the posture of the bottle meets the action requirement.

In one embodiment, the preparatory posture is convenient for the second arm to start the action of grasping the bottle at any time, and is a safe and stable posture for the second arm.

Operation 614: Predict trajectory information of the bottle in the air.

In one embodiment, after the bottle is separated from the forearm, trajectory information in a world coordinate system or relative to a center of mass coordinate system of the first arm after the bottle is thrown is predicted based on time sequence information of a tactile position and force magnitude before the forearm is separated from the bottle, a joint angle position, a velocity, and current information of the robotic arm, and visual sensing information.

Operation 616: Control the second arm to move according to the predicted trajectory information.

In one embodiment, according to the trajectory information of the bottle in the air, the second arm moves toward a moving position and direction of the bottle, and moves at a speed similar to that of the bottle when the second arm is close to the posture of the bottle. A time sequence of a position and a posture of the second arm is planned according to the trajectory information of the bottle in the air. The second arm is controlled to move based on the time sequence.

Operation 618: Control the second arm to close a robotic hand at an end and grasp the bottle.

In one embodiment, the second arm grasps the bottle with the robotic hand at the end. According to the time sequence obtained based on the trajectory information of the bottle in the air, when the bottle approaches a palm, a position of each joint angle of the robotic hand is controlled to control the robotic hand to switch from an open posture to a closed posture. Accordingly, the robotic arm completes the action of grasping the flying bottle.

Operation 620: Control the second arm to catch the thrown three-dimensional object at any position other than the end, and re-balance the three-dimensional object at any position other than the end.

The second arm performs nonprehensile manipulation on the three-dimensional object at any position other than the end. Contact between any position on the second arm other than the end and the three-dimensional object does not constitute at least one of form closure and force closure for the three-dimensional object. The three-dimensional object is re-balanced on the second arm. In this operation, an objective of controlling the second arm is to ensure that the three-dimensional object is in a balance state on the second arm, and always in balance on the second arm without falling.

In conclusion, according to the method provided in this embodiment, a method for using a robotic arm is provided. The robotic arm can first throw the three-dimensional object, catch the three-dimensional object at any position other than the end, and re-balance the three-dimensional object. The controller controls the robotic arm to implement the action of throwing and catching the three-dimensional object. Therefore, a method for controlling a robotic arm to throw and catch a three-dimensional object at any position other than an end and maintain the balance of the three-dimensional object is developed.

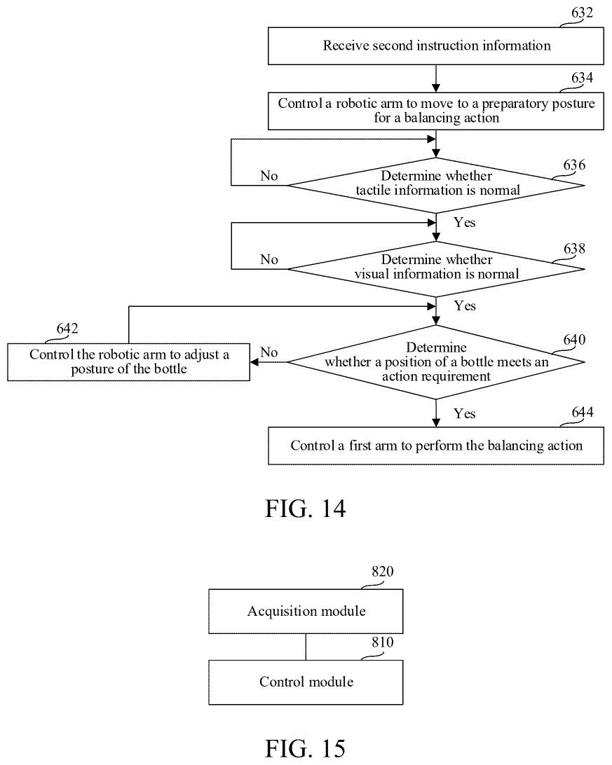

FIG. 14 is a flowchart of a robotic arm control method according to an embodiment of this application. The method may be performed by a controller of a robotic arm. The method includes:

Operation 632: Receive second instruction information.

In one embodiment, in a case that the second instruction information is not received, the robotic arm continuously waits for a user instruction in a preset instruction preparatory posture. The second instruction information may be transmitted by an input device such as a voice, a gesture, a keyboard, or a remote control. The second instruction information may be obtained through AI-based cluster analysis and pattern recognition of a voice and a gesture, or may be obtained through instruction signal transmission and parsing. The second instruction information is configured for instructing the robotic arm to balance a three-dimensional object (such as a bottle) placed at any position on the robotic arm other than an end.

Operation 634: Control the robotic arm to move to a preparatory posture for a balancing action.

The robotic arm is controlled to move to a preparatory posture in which a forearm throws a bottle, and the preparatory posture is a preset posture of the robotic arm. In one embodiment, the preparatory posture is convenient for the forearm to start the action of balancing the bottle at any time, and is a safe and stable posture for the robotic arm.

Specifically, an initial posture may be set as that a first arm of a dual-robotic-arm platform straightens and points to the right front.

Operation 636: Determine whether tactile information is normal.

In one embodiment, in a case that it is determined that the tactile information is abnormal, this operation is repeatedly performed until normal tactile information is acquired. Cases of abnormal tactile information include that no tactile signal is received, and a received tactile signal is abnormal.

Operation 638: Determine whether visual information is normal in a case that it is determined that the tactile information is normal.

In one embodiment, in a case that it is determined that the visual information is abnormal, this operation is repeatedly performed until normal visual information is acquired. Cases of abnormal visual information include that no visual signal is received, and a received visual signal is abnormal.

Operation 640: Determine whether a position of a bottle meets an action requirement in a case that it is determined that the visual information is normal.

The posture of the bottle is determined through fusion of the received visual information and the received tactile information, and is configured to indicate a position posture of the bottle on the robotic arm. In one embodiment, the action requirement is a requirement for maintaining the bottle stationary on the robotic arm, and the action requirement is obtained through planning in a dynamic model including the robotic arm and the bottle, or is preset. In one embodiment, when the bottle is in a relatively unstable state, the posture of the bottle does not meet the action requirement. For descriptions about the relatively unstable state of the bottle, refer to sub-operation 21. Details are not described herein again.

Operation 642: Control the robotic arm to adjust a posture of the bottle in a case that the posture of the bottle does not meet the action requirement.

In one embodiment, in a case that the posture of the bottle does not meet the action requirement, the robotic arm is controlled to move, to indirectly adjust the posture of the bottle until the posture of the bottle meets the action requirement. In one embodiment, by controlling the robotic arm to adjust the posture of the bottle until the posture of the bottle meets the action requirement, the bottle in the relatively unstable state is first adjusted to be detached from the relatively unstable state, and then the first arm is controlled to perform the balancing action, to maintain the bottle stationary on the robotic arm.

Operation 644: Control a first arm to perform the balancing action in a case that the posture of the bottle meets the action requirement.

In one embodiment, the balancing action performed by the first arm includes: the three-dimensional object is expected to be in a static balance state, that is, the three-dimensional object is stationary on the robotic arm. The three-dimensional object is expected to be in a dynamic balance state, that is, the three-dimensional object moves or rolls on the robotic arm without falling.

Further, an action performed by the robotic arm may include, but is not limited to, at least one of the following: grasping, throwing, and catching actions of a robotic hand at the end of the robotic arm, actions of inserting into a hole, installing and removing a screw, and mounting and assembling of an end tool of the robotic arm, actions of opening a door, closing a door, and grasping an object on a desktop and in a working space of the robotic hand at the end of the robotic arm, and the like.

In conclusion, the embodiments of this application provide a method for using a robotic arm, to balance a three-dimensional object at any position on the robotic arm other than an end without falling. A control signal can be determined for the robotic arm according to posture information and expected posture information of a dynamic system constructed based on the robotic arm and the three-dimensional object, to control the robotic arm.

Those of ordinary skill in the art may understand that the foregoing embodiments may be implemented independently, or the foregoing embodiments may be combined in different manners to form new embodiments for implementing the robotic arm control method of this application.

FIG. 15 is a block diagram of a robotic arm control apparatus according to an embodiment of this application. A three-dimensional object is placed at any position on a robotic arm other than an end, and the apparatus includes: a control module 810, configured to perform operation 510 in the embodiment in FIG. 4; and an acquisition module 820, configured to perform operation 515 in the embodiment in FIG. 4. The control module 810 is further configured to perform operation 520 in the embodiment in FIG. 4. The acquisition module 820 is further configured to perform operation 525 in the embodiment in FIG. 4. The control module 810 is further configured to perform operation 530 in the embodiment in FIG. 4.

In an alternative design of this application, the robotic arm includes a first arm; and the control module 810 is further configured to:
control the first arm to throw the three-dimensional object;
control, based on a first control signal, the first arm to catch the thrown three-dimensional object; and
control the first arm based on a second control signal, to maintain the three-dimensional object in a force balance state again at any position other than an end.

In an alternative design of this application, the robotic arm includes a first arm and a second arm that move independently of each other; and the control module 810 is further configured to:
control the first arm to throw the three-dimensional object;
control, based on a first control signal, the second arm to catch the thrown three-dimensional object; and
control the second arm based on a second control signal, to maintain the three-dimensional object in a force balance state again at any position other than an end.

In an alternative design of this application, the acquisition module 820 is further configured to perform operation 512 in the embodiment in FIG. 7. Motion trajectory information is a parabolic trajectory of the three-dimensional object after the three-dimensional object is separated from the robotic arm. The first control signal is determined according to a first actual posture of the robotic arm and the motion trajectory information of the three-dimensional object.

In an alternative design of this application, the acquisition module 820 is further configured to:
determine a first expected posture of the robotic arm according to the motion trajectory information of the three-dimensional object, the first expected posture being configured to indicate posture information of the robotic arm catching the thrown three-dimensional object; and
determine the first control signal according to a difference between a first actual posture and the first expected posture.

In an alternative design of this application, the first actual posture includes an angle and an angular velocity of rotation of the robotic arm about a first rotation axis, the first expected posture includes an expected angle and an expected angular velocity of rotation of the robotic arm about the first rotation axis, and the first control signal includes a first control torque; and the acquisition module 820 is further configured to:

determine the first control torque according to a difference between the angle and the expected angle, and a difference between the angular velocity and the expected angular velocity, the first control torque being configured to indicate a torque applied in a roll angle direction of rotation of the robotic arm about the first rotation axis, and the first rotation axis being a horizontal line perpendicular to the robotic arm; and/or the first control torque being configured to indicate a torque applied in a pitch angle direction of rotation of the robotic arm about the first rotation axis, and the first rotation axis being an extension line of the robotic arm.

In an alternative design of this application, the acquisition module 820 is further configured to:
acquire a second actual posture, the second actual posture being contact information of the robotic arm and the three-dimensional object.

The second control signal is determined according to the second actual posture and a second expected posture, and the second expected posture is configured to indicate posture information of the robotic arm balancing the three-dimensional object on the robotic arm.

In an alternative design of this application, the acquisition module 820 is further configured to:
determine the second control signal according to a difference between the second actual posture and the second expected posture.

In an alternative design of this application, the second actual posture includes position information of a center of mass of the three-dimensional object in a direction of a second rotation axis and an offset velocity of the three-dimensional object in the direction of the second rotation axis, the second expected posture includes an expected position of the center of mass of the three-dimensional object in the direction of the second rotation axis and an expected velocity of the three-dimensional object in the direction of the second rotation axis, and the second control signal includes a second control torque; and the acquisition module 820 is further configured to: determine the second control torque according to a difference between the position information and the expected position, and a difference between the offset velocity and the expected velocity. The second control torque is configured to indicate a torque applied in a roll angle direction of rotation of the robotic arm about the second rotation axis, and the second rotation axis is a horizontal line perpendicular to the robotic arm; and/or the second control torque is configured to indicate a torque applied in a pitch angle direction of rotation of the robotic arm about the second rotation axis, and the second rotation axis is an extension line of the robotic arm.

In an alternative design of this application, the acquisition module 820 is configured to:
acquire the second actual posture based on a visual sensor; or
acquire the second actual posture based on the visual sensor and a tactile sensor.

In an alternative design of this application, the acquisition module 820 is further configured to:
acquire an image by using the visual sensor, the image being configured to display that the three-dimensional object is placed on the robotic arm; and
determine the second actual posture according to an image processing result obtained through image processing.

In an alternative design of this application, the acquisition module 820 is further configured to: determine first information of the three-dimensional object in a first direction based on the visual sensor; determine second information of the three-dimensional object in a second direction based on the tactile sensor; and fuse the first information and the second information, to obtain the second actual posture.

The first direction is a direction of a horizontal line perpendicular to the robotic arm, and the second direction is a direction of an extension line of the robotic arm.

In an alternative design of this application, the acquisition module 820 is further configured to perform operation 502 in the embodiment in FIG. 10. A third expected posture is configured to indicate posture information of the robotic arm that is separated from the three-dimensional object, to enable the three-dimensional object to obtain a vertical upward velocity.

In an alternative design of this application, the acquisition module 820 is further configured to perform operation 504 in the embodiment in FIG. 10. The action of throwing up the three-dimensional object of the robotic arm is controlled based on a third control signal.

In an alternative design of this application, the acquisition module 820 is further configured to:
acquire a fourth expected posture of the robotic arm, the fourth expected posture being configured to indicate posture information of the robotic arm that is in contact with the three-dimensional object and obtains a vertical downward velocity; and
determine a fourth control signal for the robotic arm according to a fourth actual posture and the fourth expected posture of the robotic arm.

The control module 810 is further configured to: control, according to the third control signal and the fourth control signal, the robotic arm to throw the three-dimensional object. The third control signal is configured to control the robotic arm to be separated from the three-dimensional object, to enable the three-dimensional object to obtain the vertical upward velocity; and the fourth control signal is configured to control the robotic arm to be in contact with the three-dimensional object and obtain the vertical downward velocity.

In an alternative design of this application, the acquisition module 820 is further configured to perform operation 535 in the embodiment in FIG. 12; and the control module 810 is further configured to perform operation 540 in the embodiment in FIG. 12.

In an alternative design of this application, the acquisition module 820 is further configured to:
acquire motion trajectory information of the three-dimensional object, the motion trajectory information being a parabolic trajectory of the three-dimensional object after the three-dimensional object is separated from the robotic arm; and a grasp control signal being determined according to the first actual posture of the robotic arm and the motion trajectory information of the three-dimensional object.

When the apparatus provided in the foregoing embodiments implements its functions, it is illustrated only with one embodiment of division of the foregoing functional modules. In some embodiments, the foregoing functions may be allocated to and completed by different functional modules according to actual requirements. That is, an internal structure of a device is divided into different functional modules, to complete all or some of the functions described above.

Specific operation implementation manners of the modules in the apparatus in the foregoing embodiments have been described in detail in the embodiments about the method. Technical effects obtained by performing operations by the modules are the same as the technical effects in the embodiments related to the method, which are not described in detail herein.

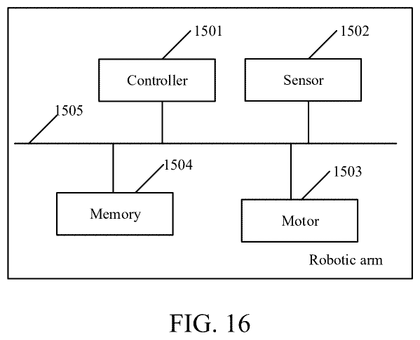

FIG. 16 is a schematic structural block diagram of a robotic arm according to an embodiment of this application. The robotic arm in this embodiment may include: one or more controllers 1501; one or more sensors 1502, one or more motor 1503, and a memory 1504. The controller 1501, the sensor 1502, the motor 1503, and the memory 1504 are connected via a bus 1505. The memory 1504 is configured to store a computer program. The computer program includes program instructions. The controller 1501 is configured to execute the program instructions stored in the memory 1504. The memory 1504 may include a volatile memory such as a random-access memory (RAM). Alternatively, the memory 1504 may include a non-volatile memory such as a flash memory or a solid-state drive (SSD). The memory 1504 may further include a combination of the foregoing types of memories.

The controller 1501 may be a central processing unit (CPU). The controller 1501 may further include a hardware chip. The hardware chip may be an application-specific integrated circuit (ASIC), a programmable logic device (PLD), or the like. The PLD may be a field-programmable gate array (FPGA), a Generic Array Logic (GAL), or the like. Alternatively, the controller 1501 may be a combination of the foregoing structures.

In the embodiments of this application, the memory 1504 is configured to store a computer program. The computer program includes program instructions. The controller 1501 is configured to execute the program instructions stored in the memory 1504, to implement the operations in the foregoing robotic arm control method.

In an embodiment, the controller 1501 is configured to call the program instructions, to perform operation 510, operation 520, and operation 530 in the embodiment in FIG. 4.

In one embodiment, the embodiments of this application further provide a robot. The robot includes the foregoing robotic arm. The robotic arm may be configured to implement the robotic arm control method provided in the foregoing method embodiments. For a structure of the robotic arm, refer to the foregoing descriptions, and for a robotic arm control method, refer to the foregoing a plurality of method embodiments. Details are not described herein again.

The embodiments of this application further provide a robotic arm, which includes a controller and a memory. The memory has at least one piece of program code stored therein, and the controller loads and executes the at least one piece of program code to implement the robotic arm control method provided in the foregoing method embodiments. The embodiments of this application further provide a computer device, which includes a processor and a memory. The memory has at least one program stored therein, and the processor loads and executes the at least one program to implement the robotic arm control method provided in the foregoing method embodiments.

The embodiments of this application further provide a computer-readable storage medium, which has a computer program stored therein. A processor executes the computer program to implement the robotic arm control method provided in the foregoing method embodiments. In an embodiment, the computer-readable storage medium includes: a read-only memory (ROM), an RAM, an SSD, an optical disc, or the like. The RAM may include a resistance RAM (ReRAM) and a dynamic RAM (DRAM). The serial numbers of the foregoing embodiments of this application are merely for description purpose but do not imply the preference among the embodiments.

Those of ordinary skill in the art may understand that all or some of the operations in the foregoing embodiments may be implemented by hardware, or may be implemented by a program instructing relevant hardware. The program may be stored in a computer-readable storage medium. The storage medium may be an ROM, a magnetic disk, an optical disc, or the like. The foregoing descriptions are merely embodiments of this application, but are not intended to limit this application. Any modification, equivalent replacement, or improvement made within the spirit and principle of this application falls within the scope of protection of this application.

The embodiments of this application further provide a chip, which includes a programmable logic circuit and/or program. The chip is configured to implement the robotic arm control method provided in the foregoing method embodiments. The embodiments of this application further provide a computer program product, which includes computer instructions. The computer instructions are stored in a computer-readable storage medium. A processor of a computer device reads the computer instructions from the computer-readable storage medium and executes the computer instructions, to cause the computer device to perform the robotic arm control method according to any one of the foregoing embodiments.

Those of ordinary skill in the art may understand that all or some of the operations in the foregoing embodiments may be implemented by hardware, or may be implemented by a program instructing relevant hardware. The program may be stored in a computer-readable storage medium. The storage medium may be an ROM, a magnetic disk, an optical disc, or the like. Those skilled in the art are aware that in one or more of the foregoing examples, the functions described in the embodiments of this application may be implemented by using hardware, software, firmware, or any combination thereof. When implemented by using software, the functions may be stored in a computer-readable medium or may be transmitted as one or more instructions or code in a computer-readable medium. The computer-readable medium includes a computer storage medium and a communication medium. The communication medium includes any medium that enables a computer program to be transmitted from one place to another. The storage medium may be any available medium accessible to a general-purpose or dedicated computer.

What is claimed is:

1. A robotic arm control method, the method being performed by a controller of a robotic arm and a three-dimensional object being placed at any position other than an end on the robotic arm, and the method comprising:
controlling the robotic arm to throw the three-dimensional object;
acquiring a first control signal;
controlling, based on the first control signal, the robotic arm to catch the thrown three-dimensional object, the robotic arm catching the three-dimensional object at any position other than the end;
acquiring a second control signal; and
controlling the robotic arm based on the second control signal, to maintain the three-dimensional object in a force balance state at any position other than the end.

2. The method according to claim 1, wherein the robotic arm comprises a first arm, and the controlling the robotic arm to throw the three-dimensional object comprises:
controlling the first arm to throw the three-dimensional object;
the controlling, based on the first control signal, the robotic arm to catch the thrown three-dimensional object comprises:
controlling, based on the first control signal, the first arm to catch the thrown three-dimensional object; and
the controlling the robotic arm based on the second control signal, to maintain the three-dimensional object in a force balance state at any position other than the end comprises:
controlling the first arm based on the second control signal, to maintain the three-dimensional object in the force balance state at any position other than the end.

3. The method according to claim 1, wherein the robotic arm comprises a first arm and a second arm that move independently of each other;
the controlling the robotic arm to throw the three-dimensional object comprises:
controlling the first arm to throw the three-dimensional object;
the controlling, based on the first control signal, the robotic arm to catch the thrown three-dimensional object comprises:
controlling, based on the first control signal, the second arm to catch the thrown three-dimensional object; and
the controlling the robotic arm based on the second control signal, to maintain the three-dimensional object in a force balance state at any position other than the end comprises:
controlling the second arm based on the second control signal, to maintain the three-dimensional object in the force balance state at any position other than the end.

4. The method according to claim 1, wherein the method further comprises:
acquiring motion trajectory information of the three-dimensional object, the motion trajectory information being a parabolic trajectory of the three-dimensional object after the three-dimensional object is separated from the robotic arm, and
the first control signal being determined according to a first actual posture of the robotic arm and the motion trajectory information of the three-dimensional object.

5. The method according to claim 4, wherein the acquiring a first control signal comprises:
determining a first expected posture of the robotic arm according to the motion trajectory information of the three-dimensional object, the first expected posture being configured to indicate posture information of the robotic arm catching the thrown three-dimensional object; and
determining the first control signal according to a difference between the first actual posture and the first expected posture.

6. The method according to claim 5, wherein the first actual posture comprises an angle and an angular velocity of rotation of the robotic arm about a first rotation axis, the first expected posture comprises an expected angle and an expected angular velocity of rotation of the robotic arm about the first rotation axis, and the first control signal comprises a first control torque; and
the determining the first control signal according to a difference between the first actual posture and the first expected posture comprises:
determining the first control torque according to a difference between the angle and the expected angle, and a difference between the angular velocity and the expected angular velocity,
the first control torque being configured to indicate a torque applied in a roll angle direction of rotation of the robotic arm about the first rotation axis, and the first rotation axis being a horizontal line perpendicular to the robotic arm; and/or the first control torque being configured to indicate a torque applied in a pitch angle direction of rotation of the robotic arm about the first rotation axis, and the first rotation axis being an extension line of the robotic arm.

7. The method according to claim 1, wherein the method further comprises:
acquiring a second actual posture, the second actual posture being contact information of the robotic arm and the three-dimensional object,
the second control signal being determined according to the second actual posture and a second expected posture, and the second expected posture being configured to indicate posture information of the robotic arm balancing the three-dimensional object on the robotic arm.

8. The method according to claim 7, wherein the acquiring a second control signal comprises:
determining the second control signal according to a difference between the second actual posture and the second expected posture.

9. The method according to claim 8, wherein the second actual posture comprises position information of a center of mass of the three-dimensional object in a direction of a second rotation axis and an offset velocity of the three-dimensional object in the direction of the second rotation axis, the second expected posture comprises an expected position of the center of mass of the three-dimensional object in the direction of the second rotation axis and an expected velocity of the three-dimensional object in the direction of the second rotation axis, and the second control signal comprises a second control torque; and
the determining the second control signal according to a difference between the second actual posture and the second expected posture comprises:
determining the second control torque according to a difference between the position information and the expected position, and a difference between the offset velocity and the expected velocity,
the second control torque being configured to indicate a torque applied in a roll angle direction of rotation of the robotic arm about the second rotation axis, and the second rotation axis being the horizontal line perpendicular to the robotic arm; and and/or the second control torque being configured to indicate a torque applied in a pitch angle direction of rotation of the robotic arm about the second rotation axis, and the second rotation axis being the extension line of the robotic arm.

10. The method according to claim 7, wherein the acquiring a second actual posture comprises:
acquiring the second actual posture based on a visual sensor; or
acquiring the second actual posture based on the visual sensor and a tactile sensor.

11. The method according to claim 10, wherein the acquiring the second actual posture based on a visual sensor comprises:
acquiring an image by using the visual sensor, the image being configured to display that the three-dimensional object is placed on the robotic arm; and
determining the second actual posture according to an image processing result obtained through image processing.

12. The method according to claim 10, wherein the acquiring the second actual posture based on the visual sensor and a tactile sensor comprises:
determining first information of the three-dimensional object in a first direction based on the visual sensor;
determining second information of the three-dimensional object in a second direction based on the tactile sensor; and
fusing the first information and the second information, to obtain the second actual posture,
the first direction being a direction of the horizontal line perpendicular to the robotic arm, and the second direction being a direction of the extension line of the robotic arm.

13. The method according to claim 1, wherein the method further comprises:
acquiring a third expected posture of the robotic arm, the third expected posture being configured to indicate posture information of the robotic arm that is separated from the three-dimensional object, to enable the three-dimensional object to obtain a vertical upward velocity; and
determining a third control signal for the robotic arm according to a third actual posture and the third expected posture of the robotic arm,
the action of throwing up the three-dimensional object of the robotic arm being controlled based on the third control signal.

14. The method according to claim 1, wherein the method further comprises:
acquiring a grasp control signal; and
controlling, based on the grasp control signal, the end of the robotic arm to grasp the thrown three-dimensional object, the grasped three-dimensional object being in the force balance state.

15. The method according to claim 14, wherein the method further comprises:
acquiring motion trajectory information of the three-dimensional object, the motion trajectory information being a parabolic trajectory of the three-dimensional object after the three-dimensional object is separated the robotic arm,
the grasp control signal being determined according to a first actual posture of the robotic arm and the motion trajectory information of the three-dimensional object.

16. A robotic arm, comprising a memory and a controller,
the memory having at least one piece of program code stored therein, and the controller loading and executing the program code to implement a robotic arm control method, the method being performed by a controller of the robotic arm and a three-dimensional object being placed at any position other than an end on the robotic arm, and the method comprising:
controlling the robotic arm to throw the three-dimensional object;
acquiring a first control signal;
controlling, based on the first control signal, the robotic arm to catch the thrown three-dimensional object, the robotic arm catching the three-dimensional object at any position other than the end;
acquiring a second control signal; and
controlling the robotic arm based on the second control signal, to maintain the three-dimensional object in a force balance state at any position other than the end.

17. The robotic arm according to claim 16, wherein the robotic arm comprises a first arm, and the controlling the robotic arm to throw the three-dimensional object comprises:
controlling the first arm to throw the three-dimensional object;
the controlling, based on the first control signal, the robotic arm to catch the thrown three-dimensional object comprises:
controlling, based on the first control signal, the first arm to catch the thrown three-dimensional object; and
the controlling the robotic arm based on the second control signal, to maintain the three-dimensional object in a force balance state at any position other than the end comprises:
controlling the first arm based on the second control signal, to maintain the three-dimensional object in the force balance state at any position other than the end.

18. The robotic arm according to claim 16, wherein the robotic arm comprises a first arm and a second arm that move independently of each other;
the controlling the robotic arm to throw the three-dimensional object comprises:
controlling the first arm to throw the three-dimensional object;
the controlling, based on the first control signal, the robotic arm to catch the thrown three-dimensional object comprises:
controlling, based on the first control signal, the second arm to catch the thrown three-dimensional object; and
the controlling the robotic arm based on the second control signal, to maintain the three-dimensional object in a force balance state at any position other than the end comprises:
controlling the second arm based on the second control signal, to maintain the three-dimensional object in the force balance state at any position other than the end.

19. A non-transitory computer-readable storage medium, having a computer program stored therein, a processor executing the computer program to implement a robotic arm control method, the method being performed by a controller of the robotic arm and a three-dimensional object being placed at any position other than an end on the robotic arm, and the method comprising:
controlling the robotic arm to throw the three-dimensional object;
acquiring a first control signal;
controlling, based on the first control signal, the robotic arm to catch the thrown three-dimensional object, the robotic arm catching the three-dimensional object at any position other than the end;
acquiring a second control signal; and
controlling the robotic arm based on the second control signal, to maintain the three-dimensional object in a force balance state at any position other than the end.

20. The computer-readable storage medium according to claim 19, wherein the robotic arm comprises a first arm, and the controlling the robotic arm to throw the three-dimensional object comprises:
controlling the first arm to throw the three-dimensional object;
the controlling, based on the first control signal, the robotic arm to catch the thrown three-dimensional object comprises:
controlling, based on the first control signal, the first arm to catch the thrown three-dimensional object; and
the controlling the robotic arm based on the second control signal, to maintain the three-dimensional object in a force balance state at any position other than the end comprises:
controlling the first arm based on the second control signal, to maintain the three-dimensional object in the force balance state at any position other than the end.
